(19) United States
(12) Patent Application Publication
(10) Pub. No.: US 2025/0014811 A1
(43) Pub. Date: Jan. 9, 2025

(54) Transformer, Method for Operating Transformer, Radio Frequency Chip, and Electronic Device

(71) Applicant: Huawei Technologies Co., Ltd., Shenzhen (CN)

(72) Inventors: Wanyi Guo, Leuven (BE); Kefeng Han, Shenzhen (CN); Dongdong Guo, Shenzhen (CN)

(21) Appl. No.: 18/891,106

(22) Filed: Sep. 20, 2024

Related U.S. Application Data
(63) Continuation of application No. PCT/CN2022/082118, filed on Mar. 21, 2022.

(51) Int. Cl. H01F 27/30; H01F 38/14

(52) U.S. Cl. CPC H01F 27/306; H01F 38/14

(57) ABSTRACT

A transformer includes a first inductor and a second inductor that are coupled to each other. The first inductor includes a plurality of parallel-connected induction coils. The second inductor includes a plurality of serial-connected induction coils. At least one of the plurality of parallel-connected induction coils and at least one of the plurality of serial-connected induction coils are adjacently disposed in a coupling manner.

### CROSS-REFERENCE TO RELATED APPLICATIONS

This is a continuation of International Patent Application No. PCT/CN2022/082118 filed on Mar. 21, 2022, the disclosure of which is hereby incorporated by reference in its entirety.

### TECHNICAL FIELD

This disclosure relates to the field of radio frequency technologies, and in particular, to a transformer, a method for operating the transformer, a radio frequency chip, and an electronic device.

### BACKGROUND

Rapid development of wireless communication technologies greatly changes people's lives. Currently, electronic devices such as smartphones and tablet computers that support applications such as third generation (3G)/fourth generation (4G)/fifth generation (5G) mobile communication, a wireless local area network (WLAN), and a Wireless Interoperability for Microwave Access (WiMAX) have become standard configurations in people's daily lives, and a radio frequency chip is an important component for the electronic device to complete interaction.

A transformer is often used in the design of a radio frequency chip and the like, to realize impedance conversion for designing a matching network. How to meet a current demand for high performance of the transformer is a big challenge at present.

### SUMMARY

Embodiments of this disclosure provide a transformer, a method for operating the transformer, a radio frequency chip, and an electronic device, to improve performance of the transformer.

To achieve the foregoing objective, this disclosure uses the following technical solutions.

According to a first aspect of embodiments of this disclosure, a transformer is provided. The transformer includes a first inductor and a second inductor that are coupled to each other. The first inductor includes a plurality of parallel-connected induction coils. The second inductor includes a plurality of serial-connected induction coils. At least one of the plurality of parallel-connected induction coils and at least one of the plurality of serial-connected induction coils are adjacently disposed in a coupling manner.

According to the transformer provided in this embodiment of this disclosure, after the first inductor in the transformer is set to include the plurality of parallel-connected induction coils, an inductance value of the first inductor is a sum of reciprocals of inductance values of the induction coils included in the first inductor, and a small inductance value of the first inductor may be obtained. After the second inductor in the transformer is set to include the plurality of serial-connected induction coils, an inductance value of the second inductor is a sum of inductance values of the induction coils included in the second inductor, and a large inductance value of the second inductor may be obtained. Therefore, an inductance ratio (namely, an impedance ratio) of the transformer is large. Based on this, the induction coil of the first inductor and the induction coil of the second inductor may be electromagnetically coupled, so that different quantities of induction coils of the first inductor and different quantities of induction coils of the second inductor may be electromagnetically coupled by adjusting an arrangement manner of the induction coils of the first inductor and the induction coils of the second inductor as required, so as to meet a requirement of the transformer for a high coupling coefficient. Therefore, the transformer may implement both a large inductance ratio (namely, impedance ratio) and a high coupling coefficient. In addition, quality factors of the first inductor and the second inductor are also high, and a loss of the transformer is small. When the transformer is used in a radio frequency chip, high performance requirements of the radio frequency chip for a large inductance ratio (namely, impedance ratio) and a high coupling coefficient in a scenario of impedance conversion with a large impedance ratio can be met.

In a possible implementation, the at least one of the plurality of parallel-connected induction coils and the at least one of the plurality of serial-connected induction coils are adjacently disposed in a nested manner at a same layer. The induction coil in the first inductor and the induction coil in the second inductor that are electromagnetically coupled are disposed at a same layer, to reduce a distance between the induction coil in the first inductor and the induction coil in the second inductor, so as to improve effect of electromagnetic coupling between the first inductor and the second inductor.

In a possible implementation, the induction coils of the first inductor include a first induction coil and a second induction coil, the induction coils of the second inductor include a third induction coil, and the third induction coil is disposed between the first induction coil and the second induction coil. This is a possible implementation, and is used to meet requirements for different impedance ratios and coupling coefficients.

In a possible implementation, the second inductor further includes a fourth induction coil, and the second induction coil is disposed between the third induction coil and the fourth induction coil. This is a possible implementation, and is used to meet requirements for different impedance ratios and coupling coefficients.

In a possible implementation, the first inductor further includes a fifth induction coil, and the fourth induction coil is disposed between the second induction coil and the fifth induction coil. This is a possible implementation, and is used to meet requirements for different impedance ratios and coupling coefficients.

In a possible implementation, the plurality of parallel-connected induction coils and the plurality of serial-connected induction coils are disposed at a same layer, and both an outermost ring and an innermost ring of the transformer are induction coils in the first inductor. In this way, a quantity of induction coils in the first inductor can be maximized, effect of coupling between the first inductor and the second inductor is improved, and a high coupling coefficient and a large impedance ratio can be implemented. This is a possible implementation, and is used to meet requirements for different impedance ratios and coupling coefficients.

In a possible implementation, the at least one of the plurality of parallel-connected induction coils and the at least one of the plurality of serial-connected induction coils are adjacently disposed in a stacked manner. The induction coil of the first inductor and the induction coil of the second inductor are disposed at different layers, so that a projection area of the transformer 20 may be small, and in addition, a distance between the induction coil of the first inductor and the induction coil of the second inductor may be small, to improve effect of electromagnetic coupling between the induction coil of the first inductor and the induction coil of the second inductor.

In a possible implementation, the induction coils of the first inductor include the first induction coil and the second induction coil, the induction coils of the second inductor include the third induction coil, and a projection of the first induction coil overlaps a projection of the third induction coil. This is a possible implementation, and is used to meet requirements for different impedance ratios and coupling coefficients.

In a possible implementation, the induction coils of the first inductor include the first induction coil and the second induction coil, the induction coils of the second inductor include the third induction coil, and a projection of the second induction coil overlaps a projection of the third induction coil. This is a possible implementation, and is used to meet requirements for different impedance ratios and coupling coefficients.

In a possible implementation, the induction coils of the first inductor include the first induction coil and the second induction coil, the induction coils of the second inductor include the third induction coil, and a projection of the first induction coil and a projection of the second induction coil overlap a projection of the third induction coil. This is a possible implementation, and is used to meet requirements for different impedance ratios and coupling coefficients.

In a possible implementation, at least a part of the plurality of parallel-connected induction coils are disposed at a same layer. In this way, the first inductor has a simple structure and is convenient to prepare.

In a possible implementation, at least a part of the plurality of serial-connected induction coils are disposed at a same layer. In this way, the first inductor has a simple structure and is convenient to prepare.

In a possible implementation, the first inductor further includes an induction coil connected in series to the plurality of parallel-connected induction coils. This is a possible implementation, and is used to meet requirements for different impedance ratios and coupling coefficients.

In a possible implementation, the transformer further includes a first capacitor and a second capacitor. The first capacitor is connected in parallel to the first inductor, and the second capacitor is connected in parallel to the second inductor. The first capacitor and the second capacitor are disposed, to adjust an operating frequency of the transformer.

In a possible implementation, the first inductor and the second inductor serve as one inductor group, and the transformer includes a plurality of inductor groups. First inductors in the plurality of inductor groups are connected in parallel, and second inductors in the plurality of inductor groups are connected in series. Compared with a case in which the transformer includes only one inductor group, in a case in which the transformer includes a plurality of inductor groups, inductance values of the first inductors of the transformer are smaller, and inductance values of the second inductors of the transformer are larger. Therefore, the transformer can obtain a larger inductance ratio (namely, impedance ratio). When a coupling coefficient of each inductor group is high, a high coupling coefficient of the transformer may still be maintained. Therefore, in a case in which a process is difficult to implement because a quantity of coils of the first inductor and a quantity of coils of the second inductor included in one inductor group are large, a plurality of inductor groups may be disposed to further improve the inductance ratio (namely, the impedance ratio) of the transformer.

According to a second aspect of embodiments of this disclosure, a radio frequency chip is provided, including a substrate and the transformer according to any one of the first aspect. The transformer is disposed on the substrate. The radio frequency chip provided in the second aspect of embodiments of this disclosure includes the transformer according to any one of the first aspect. Beneficial effects of the radio frequency chip are the same as the beneficial effects of the transformer. Details are not described herein again.

In a possible implementation, the radio frequency chip further includes a low impedance matching network and a high impedance matching network. The low impedance matching network is coupled to a first inductor of the transformer, and the high impedance matching network is coupled to a second inductor of the transformer. This is an application scenario.

According to a third aspect of embodiments of this disclosure, an electronic device is provided, including the radio frequency chip according to the second aspect and a circuit board. The radio frequency chip is disposed on the circuit board. The electronic device provided in the third aspect of embodiments of this disclosure includes the radio frequency chip according to any one of the second aspect. Beneficial effects of the radio frequency chip are the same as the beneficial effects of the radio frequency chip. Details are not described herein again.

According to a fourth aspect of embodiments of this disclosure, a method for operating a transformer is provided, including a transformer. The transformer includes a first inductor and a second inductor that are coupled to each other, the first inductor includes a plurality of parallel-connected induction coils, the second inductor includes a plurality of serial-connected induction coils, and at least one of the plurality of parallel-connected induction coils and at least one of the plurality of serial-connected induction coils are adjacently disposed in a coupling manner. The method for operating a transformer includes: electromagnetically coupling the first inductor and the second inductor, to couple a signal received by the first inductor to the second inductor and output the signal from the second inductor, or couple a signal received by the second inductor to the first inductor and output the signal from the first inductor. Beneficial effects of the method for operating a transformer provided in the fourth aspect of embodiments of this disclosure are the same as the beneficial effects of the transformer according to any one of the first aspect. Details are not described herein again.

In a possible implementation, the at least one of the plurality of parallel-connected induction coils and the at least one of the plurality of serial-connected induction coils are adjacently disposed in a nested manner at a same layer. That the first inductor and the second inductor are electromagnetically coupled includes: an induction coil in the first inductor and an induction coil that is in the second inductor and that is adjacent to the induction coil in the first inductor are electromagnetically coupled. This is an implementation.

In a possible implementation, the at least one of the plurality of parallel-connected induction coils and the at least one of the plurality of serial-connected induction coils are adjacently disposed in a stacked manner. That the first inductor and the second inductor are electromagnetically coupled includes: an induction coil in the first inductor and an induction coil that is in the second inductor and that is disposed in a stacked manner with the induction coil in the first inductor are electromagnetically coupled. This is an implementation.

### BRIEF DESCRIPTION OF DRAWINGS

FIG. 1A is a diagram of a framework of an electronic device according to an embodiment of this disclosure.

FIG. 1B is a diagram of a framework of a radio frequency chip according to an embodiment of this disclosure.

FIG. 2A is a diagram of a framework of an impedance conversion network according to an embodiment of this disclosure.

FIG. 2B is a diagram of an equivalent framework of an impedance conversion network according to an embodiment of this disclosure.

FIG. 2C is a diagram of an application scenario in which a low impedance drives a high impedance according to an embodiment of this disclosure.

FIG. 2D is a diagram of an application scenario in which a local oscillator buffer drives a mixer according to an embodiment of this disclosure.

FIG. 3A to FIG. 3D are layout diagrams of a transformer according to an embodiment of this disclosure.

FIG. 3E is a diagram of an equivalent circuit of the transformer shown in FIG. 3A to FIG. 3D.

FIG. 4A to FIG. 4E are layout diagrams of another transformer according to an embodiment of this disclosure.

FIG. 4F is a diagram of an equivalent circuit of the transformer shown in FIG. 4A to FIG. 4E.

FIG. 5A to FIG. 5C are layout diagrams of still another transformer according to an embodiment of this disclosure.

FIG. 6A to FIG. 6D are layout diagrams of still another transformer according to an embodiment of this disclosure.

FIG. 7A to FIG. 7D are layout diagrams of still another transformer according to an embodiment of this disclosure.

FIG. 8A to FIG. 8D are layout diagrams of still another transformer according to an embodiment of this disclosure.

FIG. 9A to FIG. 9C are layout diagrams of still another transformer according to an embodiment of this disclosure.

FIG. 10A to FIG. 10E are layout diagrams of still another transformer according to an embodiment of this disclosure.

FIG. 11 is a diagram of an equivalent circuit of a transformer according to an embodiment of this disclosure.

FIG. 12 is a layout diagram of still another transformer according to an embodiment of this disclosure.

FIG. 13 is a diagram of an equivalent circuit of another transformer according to an embodiment of this disclosure.

FIG. 14A is a diagram of an equivalent circuit of another transformer according to an embodiment of this disclosure.

FIG. 14B is a diagram of an equivalent circuit of still another transformer according to an embodiment of this disclosure.

Reference numerals: 100: electronic device; 110: processor; 120: external memory interface; 121: internal memory; 130: universal serial bus interface; 140: charging management module; 141: power management module; 142: battery; 150: wired communication system; 160: wireless communication module; 170: audio module; 170A: speaker; 170B: receiver; 170C: microphone; 170D: headset jack; 180: sensor module; 190: button; 191: motor; 192: indicator; 193: camera; 194: display; 195: subscriber identity module (SIM) card interface; 1: antenna; 2: antenna; 200: radio frequency chip; 300: baseband chip; 10: low impedance matching network; 20: transformer; 30: high impedance matching network; L₁: first inductor; L₂: second inductor; L1: induction coil 1; L2: induction coil 2; L11: first induction coil; L12: second induction coil; L15: fifth induction coil; L23: third induction coil; L24: fourth induction coil; L26: sixth induction coil; C1: first capacitor; C2: second capacitor; and L′: inductor group.

### DESCRIPTION OF EMBODIMENTS

The following describes the technical solutions in embodiments of this disclosure with reference to the accompanying drawings in embodiments of this disclosure. It is clear that the described embodiments are merely a part rather than all of embodiments of this disclosure.

Terms such as “first” and “second” mentioned below in embodiments of this disclosure are merely used for ease of description, and shall not be understood as an indication or implication of relative importance or implicit indication of a quantity of indicated technical features. Therefore, a feature limited by “first”, “second”, or the like may explicitly or implicitly include one or more features. In the descriptions of this disclosure, unless otherwise stated, “a plurality of” means two or more.

In embodiments of this disclosure, “up”, “down”, “left”, and “right” are not limited to definitions relative to directions in which components are schematically placed in accompanying drawings. It should be understood that these directional terms may be relative concepts used for relative description and clarification, and may change correspondingly based on a change of a direction in which a component in an accompanying drawing is placed.

In embodiments of this disclosure, unless otherwise specified in the context, in the entire specification and claims, the term “include” is interpreted as “open and inclusive”, that is, “include, but not limited to”. In the description of the specification, terms such as “an embodiment”, “some embodiments”, “example embodiments”, “examples”, or “some examples” are intended to indicate that specific features, structures, materials, or characteristics related to the embodiments or examples are included in at least one embodiment or example of the present disclosure. The foregoing schematic representations of the terms do not necessarily refer to a same embodiment or example. Further, the particular feature, structure, material, or characteristic may be included in any one or more embodiments or examples in any appropriate manner.

When some embodiments are described, expressions of “coupling” and its extensions may be used. For example, when some embodiments are described, the term “coupling” may be used to indicate that two or more components are in direct physical contact or electrical contact. However, the term “coupling” may also indicate that two or more components do not directly contact each other, but still collaborate or interact with each other. Embodiments disclosed herein are not necessarily limited to content of this specification.

The term “and/or” in embodiments of this disclosure describes only an association relationship for describing associated objects and represents that three relationships may exist. For example, A and/or B may represent the following three cases: only A exists, both A and B exist, and only B exists. In addition, the character “/” in this specification generally indicates an “or” relationship between the associated objects.

In embodiments of this disclosure, an example implementation is described with reference to a sectional view and/or a plane diagram and/or an equivalent circuit diagram that are/is used as idealized example accompanying drawings. In the accompanying drawings, for clarity, thicknesses of layers and regions are enlarged. Therefore, a change of a shape in the accompanying drawings due to, for example, a manufacturing technique and/or tolerance may be envisaged. Therefore, example implementations should not be construed as being limited to a shape of a region shown herein, but rather include shape deviations due to, for example, manufacturing. For example, an etching region shown as a rectangle typically has a bending characteristic. Therefore, the regions shown in the accompanying drawings are essentially examples, and their shapes are not intended to show actual shapes of regions of a device, and are not intended to limit a scope of the example implementations.

An embodiment of this disclosure provides an electronic device. The electronic device is, for example, a consumer electronic product, a home electronic product, a vehicle-mounted electronic product, a financial terminal product, or a communication electronic product. The consumer electronic product is, for example, a mobile phone, a tablet computer (pad), a notebook computer, an e-reader, a personal computer (PC), a personal digital assistant (PDA), a desktop display, a smart wearable product (for example, a smartwatch or a smart band), a virtual reality (VR) terminal device, an augmented reality (AR) terminal device, or an uncrewed aerial vehicle. The home electronic product is, for example, an intelligent lock, a television, a remote control, a refrigerator, and a small rechargeable household appliance (such as a soy milk maker or a robot vacuum). The vehicle-mounted electronic product is, for example, a vehicle-mounted navigator, or a vehicle-mounted high-density digital video disc (DVD). The financial terminal product is, for example, an automated teller machine (ATM), or a terminal for self-service business handling. For example, the communication electronic product is a communication device like a server, a memory, a radar, or a base station.

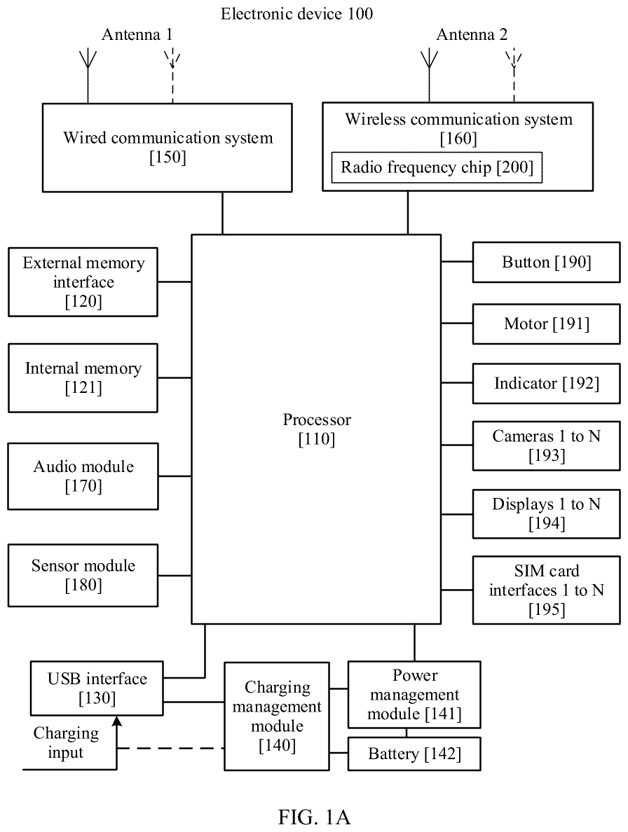

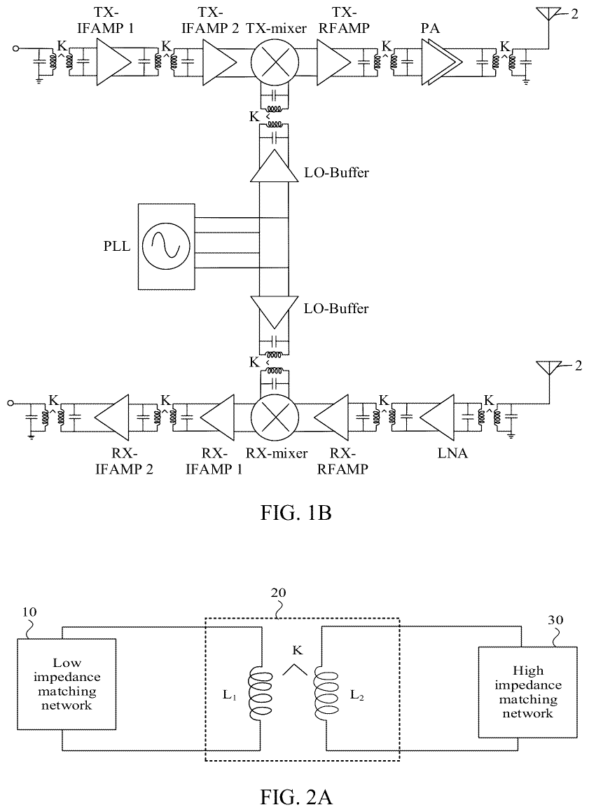

FIG. 1A is a diagram of a structure of an example of an electronic device according to an embodiment of this disclosure. As shown in FIG. 1A, an electronic device 100 may include a processor 110, an external memory interface 120, an internal memory 121, a Universal Serial Bus (USB) interface 130, a charging management module 140, a power management module 141, a battery 142, a wired communication system 150, a wireless communication system 160, an audio module 170, a speaker 170A, a receiver 170B, a microphone 170C, a headset jack 170D, a sensor module 180, a button 190, a motor 191, an indicator 192, a camera 193, a display 194, a SIM card interface 195, an antenna 1, an antenna 2, and the like.

It may be understood that the structure shown in this embodiment of this disclosure does not constitute a specific limitation on the electronic device 100. In some other embodiments of this disclosure, the electronic device 100 may include more or fewer components than those shown in the figure, a combination of some components, splits from some components, or a different component layout. The components shown in the figure may be implemented by using hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, and/or a neural-network processing unit (NPU). Different processing units may be independent components, or may be integrated into one or more processors. The controller may generate an operation control signal based on instruction operation code and a time sequence signal, to complete control of instruction reading and instruction execution.

A memory may be further disposed in the processor 110, and is configured to store instructions and data. In some embodiments, the memory in the processor 110 is a cache. The memory may store instructions or data that has just been used or cyclically used by the processor 110. If the processor 110 needs to use the instructions or the data again, the processor may directly invoke the instructions or the data from the memory. This avoids repeated access, and reduces waiting time of the processor 110, thereby improving system efficiency.

In some embodiments, the processor 110 may include one or more interfaces. The interface may include an inter-integrated circuit (I2C) interface, an inter-integrated circuit sound (I2S) interface, a pulse-code modulation (PCM) interface, a universal asynchronous receiver/transmitter (UART) interface, a mobile industry processor interface (MIPI), a general-purpose input/output (GPIO) interface, a SIM interface, a USB interface, and/or the like.

The USB interface 130 is an interface that conforms to a USB standard specification, and may be a mini USB interface, a micro USB interface, a USB type-C interface, or the like.

The charging management module 140 is configured to receive a charging input from a charger. The charger may be a wireless charger or a wired charger.

The power management module 141 is configured to connect to the battery 142, the charging management module 140, and the processor 110. The power management module 141 receives an input from the battery 142 and/or the charging management module 140, to supply power to the processor 110, the internal memory 121, the display 194, the camera 193, the wireless communication system 160, and the like. The power management module 141 may be further configured to monitor parameters such as a battery capacity, a battery cycle count, and a battery health status (electric leakage or impedance).

The electronic device 100 implements a display function through the GPU, the display 194, the application processor, and the like. The GPU is a microprocessor for image processing, and is connected to the display 194 and the application processor.

The display 194 is configured to display an image, a video, and the like. In some embodiments, the electronic device 100 may include one or N displays 194, where N is a positive integer greater than 1.

The electronic device 100 may implement a shooting function through the ISP, the camera 193, the video codec, the GPU, the display 194, the application processor, and the like.

The ISP is configured to process data fed back by the camera 193, the camera 193 is configured to capture a static image or a video, and the video codec is configured to compress or decompress a digital video.

The external memory interface 120 may be configured to connect to an external storage card, for example, a micro SD card, to extend a storage capability of the electronic device 100.

The internal memory 121 may be configured to store computer-executable program code. The executable program code includes instructions.

The electronic device 100 may implement an audio function through the audio module 170, the speaker 170A, the receiver 170B, the microphone 170C, the headset jack 170D, the application processor, and the like.

The audio module 170 is configured to convert digital audio information into an analog audio signal for output, and is also configured to convert an analog audio input into a digital audio signal. The speaker 170A is configured to convert an audio electrical signal into a sound signal. The receiver 170B is configured to convert an audio electrical signal into a sound signal. The microphone 170C is configured to convert a sound signal into an electrical signal. The headset jack 170D is configured to connect to a wired headset.

The sensor module 180 may include an image sensor, a pressure sensor, a magnetic sensor, a distance sensor, and the like. The image sensor may be, for example, a contact image sensor (CIS).

The button 190 includes a power button, a volume button, and the like. The motor 191 may generate a vibration prompt. The indicator 192 may be an indicator light, and may be configured to indicate a charging status and a power change, or may be configured to indicate a message, a missed call, a notification, and the like. The SIM card interface 195 is configured to connect to a SIM card.

A communication function of the electronic device 100 may be implemented through the antenna 1, the antenna 2, the wired communication system 150, the wireless communication system 160, the modem processor, the baseband processor, and the like.

The modem processor may include a modulator and a demodulator. The modulator is configured to modulate a to-be-sent low-frequency baseband signal into a medium-/high-frequency signal. The demodulator is configured to demodulate a received electromagnetic wave signal into a low-frequency baseband signal. Then, the demodulator transmits the low-frequency baseband signal obtained through demodulation to the baseband processor for processing. The baseband processor processes the low-frequency baseband signal, and then transmits a processed signal to the application processor. The application processor outputs a sound signal via an audio device (which is not limited to the speaker, the receiver, and the like), or displays an image or a video on the display 194.

The antenna 1 and the antenna 2 are configured to transmit and receive an electromagnetic wave signal. Each antenna in the electronic device 100 may be configured to cover one or more communication bands. Different antennas may be further multiplexed to improve antenna utilization. For example, the antenna 1 may be multiplexed as a diversity antenna of a wireless local area network. In some other embodiments, the antenna may be used in combination with a tuning switch.

The wired communication module 150 may provide a wireless communication solution that is applied to the electronic device 100 and that includes 2G/3G/4G/5G, and the like. The wired communication module 150 may include one or more filters, switches, power amplifiers, low noise amplifiers (LNAs), and the like. The wired communication module 150 may receive an electromagnetic wave through the antenna 1, perform processing such as filtering and amplification on the received electromagnetic wave, and transmit a processed electromagnetic wave to the modem processor for demodulation. The wired communication module 150 may further amplify a signal modulated by the modem processor, and convert an amplified signal into an electromagnetic wave for radiation through the antenna 1. In some embodiments, at least some functional modules of the wired communication module 150 may be disposed in the processor 110. In some embodiments, at least some functional modules of the wired communication module 150 may be disposed in a same device as at least some modules of the processor 110.

The wireless communication system 160 may provide a wireless communication solution that is applied to the electronic device 100, and that includes a WLAN (for example, a WI-FI network), BLUETOOTH (BT), a global navigation satellite system (GNSS), frequency modulation (FM), near-field communication (NFC), an infrared (IR) technology, or the like. The wireless communication module 160 may be one or more components into which one or more communication processing modules are integrated. The wireless communication module 160 receives an electromagnetic wave through the antenna 2, performs frequency modulation and filtering processing on the electromagnetic wave signal, and sends a processed signal to the processor 110. The wireless communication module 160 may further receive a to-be-sent signal from the processor 110, perform frequency modulation and amplification on the signal, and convert a processed signal into an electromagnetic wave for radiation through the antenna 2.

In some embodiments, in the electronic device 100, the antenna 1 and the wired communication module 150 are coupled, and the antenna 2 and the wireless communication module 160 are coupled, so that the electronic device 100 can communicate with a network and another device by using a wireless communication technology. The wireless communication technology may include a Global System for Mobile Communications (GSM), a General Packet Radio Service (GPRS), code-division multiple access (CDMA), wideband code-division multiple access (WCDMA), time-division synchronous code-division multiple access (TD-SCDMA), Long-term Evolution (LTE), BT, GNSS, WLAN, NFC, FM, an IR technology, and the like. The GNSS may include a Global Positioning System (GPS), a Global Navigation Satellite System (GLONASS), a BeiDou navigation satellite system (BDS), a quasi-ceiling satellite system (QZSS), and/or a satellite-based augmentation system (SBAS).

The foregoing electronic device 100 further includes a circuit board, for example, a printed circuit board (PCB). Some electronic components in the electronic device 100 such as the processor 110, the internal memory 121, and a radio frequency chip may be disposed on the circuit board.

An embodiment of this disclosure provides a radio frequency chip. As shown in FIG. 1A, a radio frequency chip 200 may be used in the foregoing wireless communication system 160. The radio frequency chip 200 is an electronic component/part that converts a radio signal into a specific radio signal waveform through communication, and sends the radio signal waveform through resonance via the antenna 2. The radio frequency chip 200 is responsible for radio frequency receiving and sending, frequency synthesis, power amplification, and the like.

The antenna 2 may or may not be packaged inside the radio frequency chip 200. In this embodiment of this disclosure, an example in which the antenna 2 is not packaged inside the radio frequency chip 200 is used for illustration.

For example, as shown in FIG. 1B, a radio frequency chip 200 is provided, and a block diagram of a transmit channel, a receive channel, and a local oscillator channel of the radio frequency chip 200 is shown.

Transmit channel: After being amplified by an intermediate frequency amplifier TX-IFAMP 1/2, an intermediate frequency (or baseband) signal is sent to a transmit frequency mixer TX-mixer. The TX-mixer performs frequency mixing on the intermediate frequency (or baseband) signal and a local oscillator signal to obtain a radio frequency signal. After being amplified by a radio frequency amplifier TX-RFAMP and a power amplifier PA, the radio frequency signal is transmitted via the antenna 2.

Receive channel: After being amplified by a low noise amplifier LNA and a radio frequency amplifier RX_RFAMP, the radio frequency signal from the antenna 2 is sent to a receive frequency mixer RX-mixer. The RX-mixer performs frequency mixing on the radio frequency signal and a local oscillator signal to obtain an intermediate frequency (or baseband) signal. After being amplified by an intermediate frequency amplifier RX_IFAMP 1/2, the signal is provided for a post-stage chip for signal processing.

Local oscillator channel: After being amplified by a local oscillator buffer (LO-buffer), a signal from a phase-locked loop PLL is provided for a receive frequency mixer and a transmit frequency mixer for frequency mixing of the received or transmitted signal.

In some embodiments, the radio frequency chip 200 may further include components such as a frequency multiplier, a variable gain amplifier, and an attenuator. Components included in the radio frequency chip 200 shown in FIG. 1B are merely examples. This is not limited.

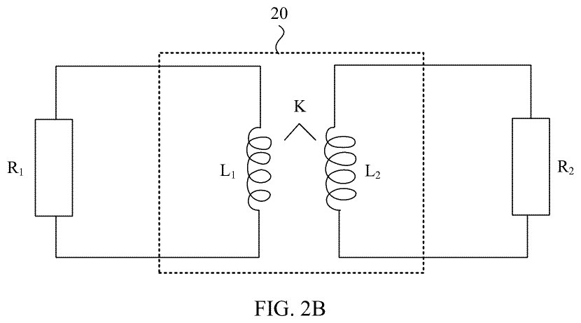

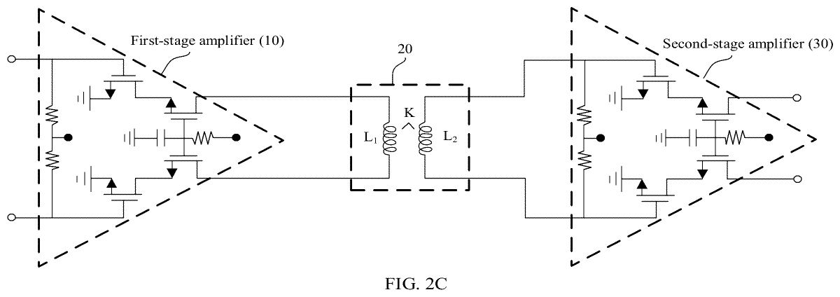

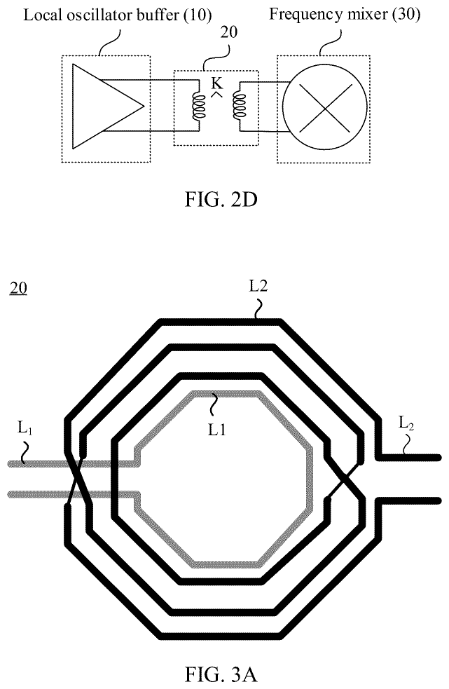

FIG. 2A shows an equivalent impedance conversion network based on a transformer. One end of a transformer 20 is coupled to a low impedance matching network 10, and the other end of the transformer 20 is coupled to a high impedance matching network 30.

The low impedance matching network 10 is relative to the high impedance matching network 30, and a specific value of an impedance of the low impedance matching network 10 does not need to be limited, provided that the impedance of the low impedance matching network 10 is less than an impedance of the high impedance matching network 30. For example, as shown in FIG. 2B, the impedance of the low impedance matching network 10 is R₁, the impedance of the high impedance matching network 30 is R₂, and R₁<R₂.

Specific structures of the low impedance matching network and the high impedance matching network are not limited in this embodiment of this disclosure, provided that the low impedance matching network and the high impedance matching network are properly disposed with reference to a specific structure of a component including the transformer 20.

The transformer 20 includes a first inductor L₁ and a second inductor L₂ whose coupling coefficient is K. The first inductor L₁ and the second inductor L₂ are mutually a primary induction coil and a secondary induction coil, an end part of the first inductor L₁ is coupled to the low impedance matching network 10, and an end part of the second inductor L₂ is coupled to the high impedance matching network 30, to implement conversion between the impedance R₁ and the impedance R₂.

When the first inductor L₁ is the primary induction coil and the second inductor L₂ is the secondary induction coil, the transformer 20 is configured to convert the impedance R₁ into the impedance R₂ (or understood as driving a high impedance by a low impedance). When the first inductor L₁ is the secondary induction coil and the second inductor L₂ is the primary induction coil, the transformer 20 is configured to convert the impedance R₂ into the impedance R₁ (or understood as driving a low impedance by a high impedance).

For example, FIG. 2C is a diagram of an application scenario in which a low impedance drives a high impedance (or a high impedance drives a low impedance). The low impedance matching network 10 may be a first-stage amplifier, and the high impedance matching network 30 may be a second-stage amplifier. A power P1 input by the first-stage amplifier to the transformer 20 is equal to I₁*R₁, where I₁ is a radio frequency current input by the first-stage amplifier. After impedance conversion is performed by the transformer 20, a power P2 output by the second-stage amplifier is equal to I₂*R₂, where I₂ is a radio frequency current flowing into the second-stage amplifier. Alternatively, for example, FIG. 2D shows an application scenario in which a local oscillator buffer drives a mixer. The low impedance matching network 10 may be the local oscillator buffer, and the high impedance matching network 30 may be the mixer.

In the transformer-based impedance conversion network, generally, an impedance ratio R is equal to an inductance ratio L. To be specific, an impedance of the low impedance matching network 10 is R₁, an impedance of the high impedance matching network 30 is R₂, an inductance value of the first inductor L₁ is L1′, an inductance value of the second inductor L₂ is L2′, and R₁/R₂=L1′/L2′. It can be learned from the foregoing descriptions that, in a process of designing the radio frequency chip 200, the foregoing impedance conversion network often needs to be used. In an application process, in one aspect, impedance conversion with a large impedance ratio R is often encountered, for example, between a LO-Buffer and a mixer, between voltage interface amplifiers during driving of a high impedance by a low impedance, and between voltage interface amplifiers during driving of a low impedance by a high impedance. Sometimes, the impedance ratio R is greater than 7 or even greater. In this case, a large impedance ratio R is required to implement impedance matching. In another aspect, during designing of the radio frequency chip 200, it is expected to reduce a loss of the transformer 20 as much as possible, to improve performance of the radio frequency chip 200. In this case, the coupling coefficient K of the transformer 20 needs to be large enough. In a radio frequency band, it is generally expected that the coupling coefficient K is greater than 0.7.

In other words, in a scenario of impedance conversion with a large impedance ratio R, both the impedance ratio R (namely, the inductance ratio L) and the coupling coefficient K need to be large to meet a requirement of the radio frequency chip 200 for performance design.

In view of this, an embodiment of this disclosure further provides a transformer 20. The transformer 20 may be used in the foregoing radio frequency chip 200, and is disposed on a substrate of the radio frequency chip 200. One component in the radio frequency chip 200 may include the transformer 20, or a plurality of components in the radio frequency chip 200 may include the transformer 20, or two components in the radio frequency chip 200 may be coupled via the transformer 20. This is not limited in embodiments of this disclosure.

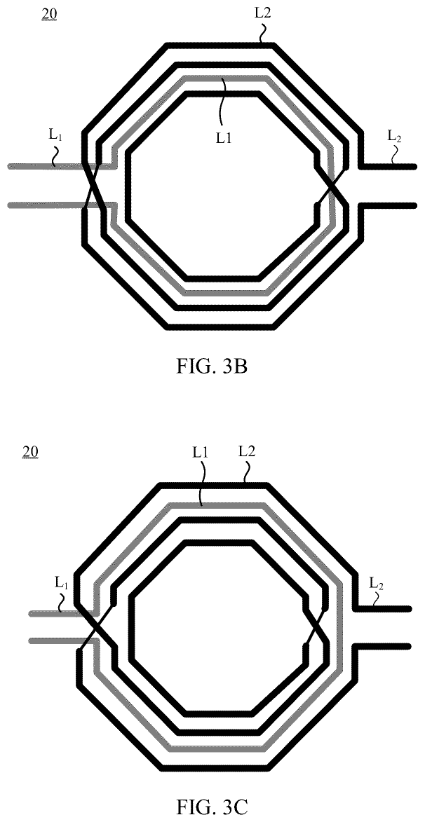

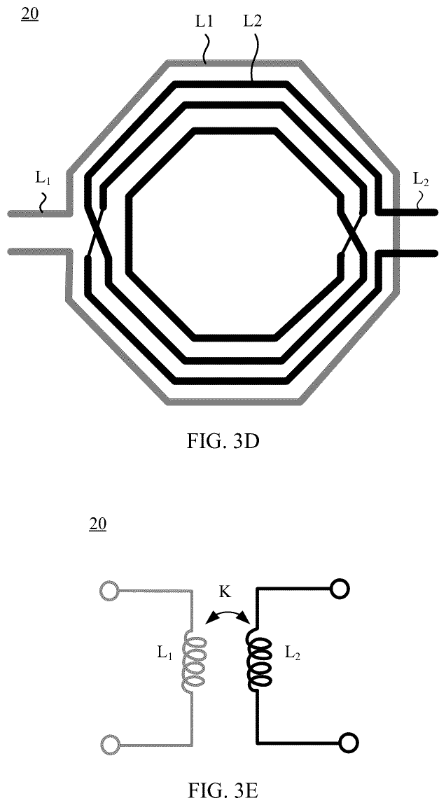

As shown in FIG. 3A, a first inductor L₁ of a transformer 20 includes one induction coil L1, and a second inductor L₂ of the transformer 20 includes a plurality of induction coils L2.

In embodiments of this disclosure, to distinguish an induction coil of the first inductor L₁ from an induction coil of the second inductor L₂, an example in which the induction coil of the first inductor L₁ is an induction coil 1 L1 and the induction coil of the second inductor L₂ is an induction coil 2 L2 is used for schematic description.

For example, as shown in FIG. 3A, the first inductor L₁ includes one induction coil 1 L1, and the second inductor L₂ of the transformer 20 includes three induction coils 2 L2.

If an inductance value of each induction coil 1 L1 of the first inductor L1 is L1, an inductance value L1′ of the first inductor L₁ is equal to L1. If inductance values of the three induction coils 2 L2 of the second inductor L₂ are L2a, L2b, and L2c, respectively, an inductance value L2′ of the second inductor L₂ is equal to L2a+L2b+L2c.

Therefore, the induction coil 1 L1 in the first inductor L₁ and the induction coils 2 L2 in the second inductor L₂ are set to a one-to-many structure, to increase an inductance ratio L (namely, an impedance ratio R) of the first inductor L₁ to the second inductor L₂.

Based on this, as shown in FIG. 3A, FIG. 3B, FIG. 3C, and FIG. 3D, a position of the induction coil 1 L1 in the first inductor L₁ is adjusted, to change relative positions and overlapping areas of the induction coil 1 L1 in the first inductor L₁ and the plurality of induction coils 2 L2 in the second inductor L₂, to attempt to adjust a coupling coefficient K of the first inductor L₁ and the second inductor L₂. Equivalent circuit diagrams of the transformers 20 shown in FIG. 3A, FIG. 3B, FIG. 3C, and FIG. 3D are the same, and are all as shown in FIG. 3E.

For example, a structure of a transformer operating in 5 gigahertz (GHz) to 10 GHz is set. It is found through simulation that, in a structure of the transformer 20, shown in FIG. 3A, in which the induction coil 1 L1 in the first inductor L₁ is located on an inner side of the plurality of induction coils 2 L2 in the second inductor L₂, the inductance value L₁′ of the first inductor L₁ is equal to 210 pH, a quality factor Q1 of the first inductor L₁ is equal to 11, the inductance value L2′ of the second inductor L₂ is equal to 1830 pH, and a quality factor Q2 of the second inductor L₂ is equal to 14. The inductance ratio L (namely, the impedance ratio R) of the first inductor L i to the second inductor L₂ can reach about 8.7, but the coupling coefficient K of the first inductor L₁ and the second inductor L₂ can only reach about 0.38. The inductance ratio L (namely, the impedance ratio R) can meet the requirement of the radio frequency chip 200 for the performance design, but the coupling coefficient K is excessively small and cannot meet the requirement of the radio frequency chip 200 for the performance design.

In a structure, shown in FIG. 3B, in which the induction coil 1 L1 in the first inductor L₁ is located at a periphery of an innermost induction coil 2 L2, the inductance value L1′ of the first inductor L₁ is equal to 296 pH, a quality factor Q1 of the first inductor L₁ is equal to 9.6, the inductance value L2′ of the second inductor L₂ is equal to 1890 pH, and a quality factor Q2 of the second inductor L₂ is equal to 15. The inductance ratio L (namely, the impedance ratio R) of the first inductor L₁ to the second inductor L₂ can only reach about 6.4, and the coupling coefficient K of the first inductor L₁ and the second inductor L₂ can only reach about 0.66. Neither the inductance ratio L (namely, the impedance ratio R) nor the coupling coefficient K can meet the requirement of the radio frequency chip 200 for the performance design.

In a structure, shown in FIG. 3C, in which the induction coil 1 L1 in the first inductor L₁ is located on an inner side of an outermost induction coil 2 L2, the inductance value L1′ of the first inductor L₁ is equal to 402 pH, a quality factor Q1 of the first inductor L₁ is equal to 10, the inductance value L2′ of the second inductor L₂ is equal to 2016 pH, and a quality factor Q2 of the second inductor L₂ is equal to 15. The coupling coefficient K of the first inductor L₁ and the second inductor L₂ can reach about 0.72, but the inductance ratio L (namely, the impedance ratio R) of the first inductor L₁ to the second inductor L₂ can only reach about 5.0. The coupling coefficient K can meet the requirement of the radio frequency chip 200 for the performance design, but the inductance ratio L (namely, the impedance ratio R) cannot meet the requirement of the radio frequency chip 200 for the performance design.

In a structure, shown in FIG. 3D, in which the induction coil 1 L1 in the first inductor L₁ is located at a periphery of the plurality of induction coils 2 L2 in the second inductor L₂, the inductance value L1′ of the first inductor L₁ is equal to 507 pH, a quality factor Q1 of the first inductor L₁ is equal to 12.5, the inductance value L2′ of the second inductor L₂ is equal to 2020 pH, and a quality factor Q2 of the second inductor L₂ is equal to 12.5. The inductance ratio L (namely, the impedance ratio R) of the first inductor L₁ to the second inductor L₂ can only reach about 3.98, and the coupling coefficient K of the first inductor L₁ and the second inductor L₂ can only reach about 0.59. Neither the inductance ratio L (namely, the impedance ratio R) nor the coupling coefficient K can meet the requirement of the radio frequency chip 200 for the performance design.

Generally, to implement a large inductance ratio L (namely, impedance ratio R), a large inductance value L2′ and a small inductance value L1′ are required. To be specific, a ratio of a quantity of coils of the first inductor L₁ to a quantity of coils of the second inductor L₂ needs to be increased, the second inductor L₂ is implemented by using more coils, and the first inductor L₁ is implemented by using fewer coils. To implement a high coupling coefficient K, an overlapping and nesting area between the first inductor L₁ and the second inductor L₂ needs to be increased. To be specific, a ratio of a quantity of coils of the first inductor L₁ to a quantity of coils of the second inductor L₂ needs to be reduced. Therefore, based on the structures shown in FIG. 3A to FIG. 3D, to implement both the large inductance ratio L (namely, impedance ratio R) and the high coupling coefficient K becomes a contradiction, only one of the conditions can be met, and it is difficult to meet both of the conditions.

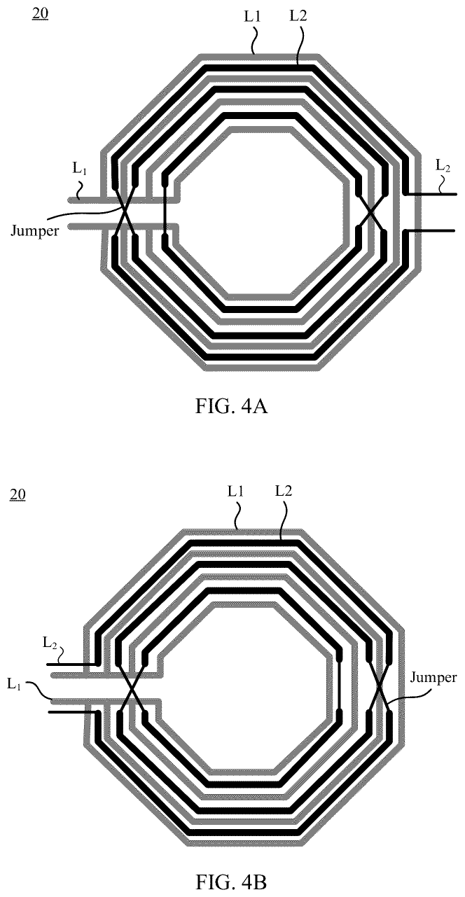

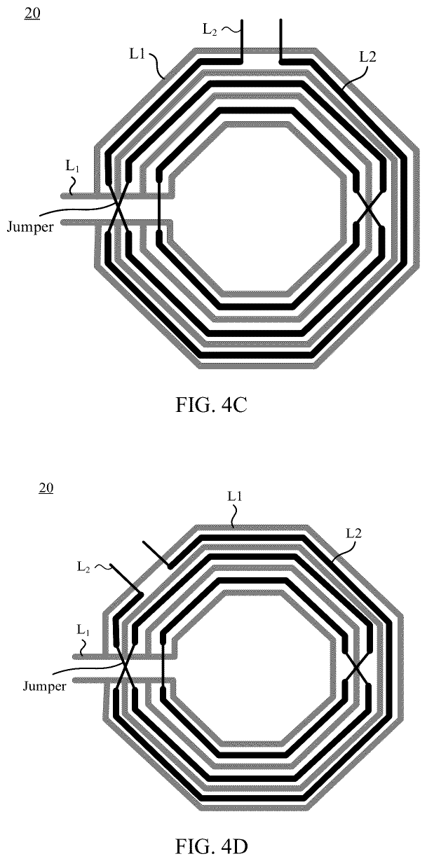

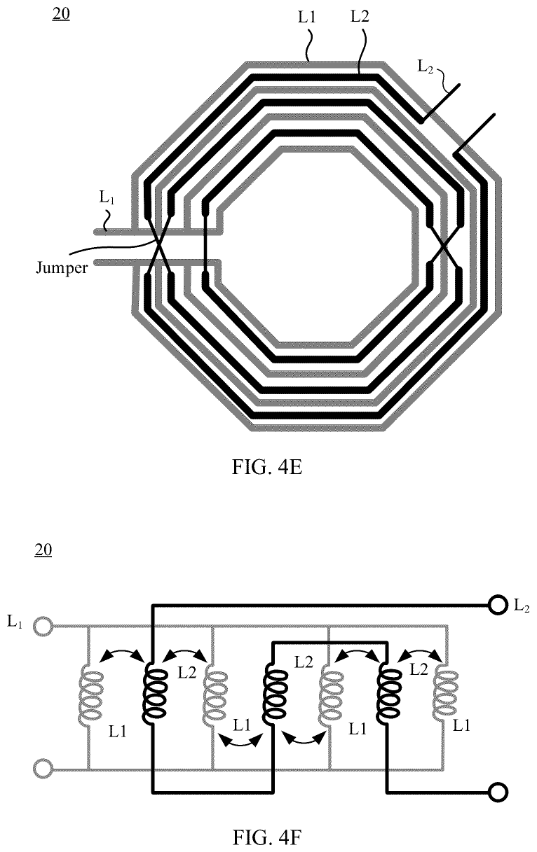

In view of this, an embodiment of this disclosure further provides a transformer 20. As shown in FIG. 4A, the transformer 20 includes a first inductor L₁ and a second inductor L₂. The first inductor L₁ includes a plurality of parallel-connected induction coils 1 L1, and the second inductor L₂ includes a plurality of serial-connected induction coils 2 L2.

There is a gap between the plurality of first induction coils 1 L1, and there is a gap between the plurality of second induction coils 2 L2. Centers (which may be understood as an air core of the transformer 20) of the plurality of induction coils 1 L1 and centers of the plurality of induction coils 2 L2 are the same, and gaps exist between the plurality of induction coils 1 L1 and the plurality of induction coils 2 L2. The gap may be a gap parallel to a plane direction in which the induction coil 1 L1 is located, or the gap may be a gap vertical to a plane direction in which the induction coil 1 L1 is located.

The first inductor L₁ and the second inductor L₂ are mutually a primary induction coil and a secondary induction coil. In a scenario in which the transformer 20 is configured to drive a high impedance with a low impedance, the first inductor L₁ serves as the primary induction coil of the transformer 20, and the second inductor L₂ serves as the secondary induction coil of the transformer 20. In a scenario in which the transformer 20 is configured to drive a low impedance with a high impedance, the second inductor L₂ serves as the primary induction coil of the transformer 20, and the first inductor L₁ serves as the secondary induction coil of the transformer 20.

Relative positions of a signal end of the first inductor L₁ and a signal end of the second inductor L₂ are not limited in embodiments of this disclosure. As shown in FIG. 4A, the signal end of the first inductor L₁ is disposed opposite to the signal end of the second inductor L₂. As shown in FIG. 4B, the signal end of the first inductor L₁ and the signal end of the second inductor L₂ are located on a same side. As shown in FIG. 4C to FIG. 4E, an included angle between the signal end of the first inductor L₁ and the signal end of the second inductor L₂ may be any angle less than 180°. For ease of description, the following describes a detailed structure of the transformer 20 by using an example in which the signal end of the first inductor L₁ is disposed opposite to the signal end of the second inductor L₂.

The first inductor L₁ includes the plurality of induction coils 1 L1 disposed in parallel, and the second inductor L₂ includes the plurality of induction coils 2 L2 disposed in series.

As shown in FIG. 4F, at least one of the plurality of parallel-connected induction coils 1 L1 of the first inductor L₁ and at least one of the plurality of serial-connected induction coils 2 L2 of the second inductor L₂ are adjacently disposed in a coupling manner.

To be specific, at least one of the plurality of parallel-connected induction coils 1 L1 of the first inductor L₁ may be electromagnetically coupled to the induction coil 2 L2. In addition, when electromagnetic coupling occurs, the induction coil 1 L1 may be electromagnetically coupled to at least one induction coil 2 L2, and the induction coil 2 L2 electromagnetically coupled to the induction coil 1 L1 and the induction coil 1 L1 may be adjacently disposed in a nested manner at a same layer, or may be adjacently disposed in a stacked manner.

In FIG. 4F, an example in which each induction coil 1 L1 and at least one induction coil 2 L2 are adjacently disposed in a coupling manner is used for illustration. FIG. 4F is a diagram of a structure of an equivalent circuit of the transformer 20. In a product structure, a person skilled in the art may use relative positions of the induction coil 1 L1 in the first inductor L₁ and the induction coil 2 L2 in the second inductor L₂, to determine whether the induction coil 1 L1 and the induction coil 2 L2 may be electromagnetically coupled. Usually, when the induction coil 1 L1 is close to the induction coil 2 L2, electromagnetic coupling may occur.

An embodiment of this disclosure further provides a signal transmission method. In a scenario in which the transformer 20 is configured to drive a high impedance with a low impedance, in a signal transmission process, a first inductor L₁ and a second inductor L₂ are electromagnetically coupled, to couple a signal received by the first inductor L₁ to the second inductor L₂, and output the signal from the second inductor L₂.

Alternatively, in a scenario in which the transformer 20 is configured to drive a low impedance with a high impedance, in a signal transmission process, a first inductor L₁ and a second inductor L₂ are electromagnetically coupled, to transmit and couple a signal received by the second inductor L₂ to the first inductor L1, and output the signal from the first inductor L₁.

According to the transformer 20 provided in this embodiment of this disclosure, the transformer 20 shown in FIG. 4A is used as an example. Inductance values of four induction coils 1 L1 of the first inductor L₁ are as follows: an inductance value of an induction coil 1 L1 at an outer ring is approximately L1a, an inductance value of an induction coil 1 L1 at a secondary outer ring is approximately L1b, an inductance value of an induction coil 1 L1 at a secondary inner ring is approximately L1c, and an inductance value of an induction coil 1 L1 at an inner ring is approximately L1d. Inductance values of three induction coils 2 L2 in the second inductor L₂ are as follows: an inductance value of an induction coil 2 L2 at an outer ring is approximately L2a, an inductance value of an induction coil 2 L2 at a middle ring is approximately L2b, and an inductance value of an induction coil 2 L2 at an inner ring is approximately L2c.

According to the transformer 20 provided in this embodiment of this disclosure, after the plurality of induction coils 1 L1 in the first inductor L₁ are connected in parallel, an inductance value L1′ of the first inductor L₁ including the plurality of induction coils 1 L1 is as follows: L1′

$$L {1}^{′} \approx \frac{1}{\frac{1}{L 1 a} + \frac{1}{L 1 b} + \frac{1}{L 1 c} + \frac{1}{L 1 d}} ,$$

and a small inductance value L1′ of the first inductor L₁ may be obtained. After the plurality of induction coils 2 L2 in the second inductor L₂ are connected in series, an inductance value L2′ of the second inductor L₂ including the plurality of induction coils 2 L2 is as follows: L2′≈L2a+L2b+L2c, and a large inductance value L2′ of the second inductor L₂ may be obtained. Therefore, an inductance ratio L (namely, an impedance ratio R) of the transformer 20 provided in this embodiment of this disclosure is large. Based on this, the induction coil 1 L1 in the first inductor L₁ and the induction coil 2 L2 in the second inductor L₂ may be electromagnetically coupled, so that different quantities of induction coils 1 L1 and different quantities of induction coils 2 L2 may be electromagnetically coupled by adjusting an arrangement manner of the induction coils 1 L1 in the first inductor L₁ and the induction coils 2 L2 in the second inductor L₂ as required, so as to meet a requirement of the transformer 20 for a high coupling coefficient K. Therefore, the transformer 20 may implement both a large inductance ratio L (namely, impedance ratio R) and a high coupling coefficient K. In addition, quality factors of the first inductor L₁ and the second inductor L₂ are also high, and a loss of the transformer 20 is small.

Based on the transformer 20 shown in FIG. 4A, it is found through simulation that, when operating at a frequency of 8 GHz, the transformer 20 has an inductance value L1′ of the first inductor L₁ is equal to 177 pH, an inductance value L2′ of the second inductor L₂ is equal to 1590 pH, a quality factor Q1 of the first inductor L₁ is equal to 12.8, and a quality factor Q2 of the second inductor L₂ is equal to 11. An inductance ratio L (namely, an impedance ratio R) of the transformer 20 can reach about 9, and a coupling coefficient K can reach about 0.75, so that both a large inductance ratio L (namely, impedance ratio R) and a high coupling coefficient K can be implemented. In addition, the quality factors of the first inductor L₁ and the second inductor L₂ are also high, and a loss of the transformer 20 is small. When the transformer 20 is used in a radio frequency chip 200, performance requirements of the radio frequency chip 200 for a large inductance ratio L (namely, impedance ratio R) and a high coupling coefficient K in a scenario of impedance conversion with a large impedance ratio R can be met, and a loss of the transformer 20 is small.

A quantity of induction coils 1 L1 in the first inductor L₁ and a quantity of induction coils 2 L2 in the second inductor L₂ are not limited in embodiments of this disclosure. In FIG. 4A, an example in which the first inductor L₁ of the transformer 20 includes the four induction coils 1 L1 and the second inductor L₂ includes the three induction coils 2 L2 is merely used for illustration.

When a layout of the transformer 20 is formed, the induction coil 1 L1 in the first inductor L₁ and the induction coil 2 L2 in the second inductor L₂ may be disposed at a same layer, or may be disposed at different layers. The plurality of induction coils 1 L1 in the first inductor L₁ may be disposed at a same layer, or may be disposed at different layers. The plurality of induction coils 2 L2 in the second inductor L₂ may be disposed at a same layer, or may be disposed at different layers. The following schematically describes disposing positions and arrangement manners of the plurality of induction coils 1 L1 and the plurality of induction coils 2 L2.

In terms of a manner in which the first inductor L₁ and the second inductor L₂ are coupled, in a possible implementation, at least one of the plurality of parallel-connected induction coils 1 L1 and at least one of the plurality of serial-connected induction coils 2 L2 are adjacently disposed in a nested manner at a same layer.

In some embodiments, the plurality of parallel-connected induction coils 1 L1 in the first inductor L1 are disposed at a same layer, the plurality of serial-connected induction coils 2 L2 in the second inductor L2 are disposed at a same layer, and the first inductor L₁ and the second inductor L₂ are disposed at a same layer.

The plurality of induction coils 1 L1 of the first inductor L₁ and the plurality of induction coils 2 L2 of the second inductor L₂ are disposed in a nested manner, and an induction coil 1 L1 in the first inductor L₁ and an induction coil 2 L2 adjacent to the induction coil 1 L1 in the second inductor L₂ are electromagnetically coupled.

Alternatively, it is understood as that the plurality of induction coils 1 L1 in the first inductor L₁ and the plurality of induction coils 2 L2 in the second inductor L₂ are arranged in a staggered manner, and are arranged outward in sequence in a direction away from a center of the transformer 20, one coil covers another coil, and adjacent coils are not coupled.

It may be understood that, in a place where the induction coil 1 L1 overlaps with the induction coil 2 L2, jumpering (at a different layer from the induction coil 1 L1 and the induction coil 2 L2) may be performed at the overlapping place in a manner of an air bridge or a dielectric bridge, so as to avoid coupling between the induction coil 1 L1 and the induction coil 2 L2. Similarly, in a place where the plurality of induction coils 2 L2 overlap, jumpering may be performed at the overlapping place in a manner of an air bridge or a dielectric bridge, so as to avoid coupling between the plurality of induction coils 2 L2.

For example, as shown in FIG. 4E, all jumpering parts are on the induction coils 2 L2 in the second inductor L₂, and a jumpering part with a thinner line in the induction coil 2 L2 is a part that overlaps the induction coil 1 L1 in the first inductor L₁. The jumpering part is at a different layer from other parts of the induction coil 1 L1 and the induction coil 2 L2. When two jumpering parts intersect, two jumpers are located at different layers. Certainly, alternatively, all the jumpering parts may be on the induction coils 1 L1, or on the induction coils 2 L2, or some jumpering parts are on the induction coil 1 L1, and some jumpering parts are on the induction coil 2 L2. This is not limited in embodiments of this disclosure, provided that the jumpering parts are properly disposed as required. The at least one induction coil 1 L1 in the first inductor L₁ and the at least one induction coil 2 L2 in the second inductor L₂ are adjacently disposed in a nested manner at a same layer, to reduce a distance between the induction coil 1 L1 and the induction coil 2 L2. In addition, this avoids an insulation layer between the induction coil 1 L1 and the induction coil 2 L2, thereby improving effect of electromagnetic coupling between the induction coil 1 L1 and the induction coil 2 L2.

In some embodiments, the plurality of induction coils 1 L1 and the plurality of induction coils 2 L2 are arranged in a nested manner.

Optionally, at least one induction coil 2 L2 is disposed between adjacent induction coils 1 L1.

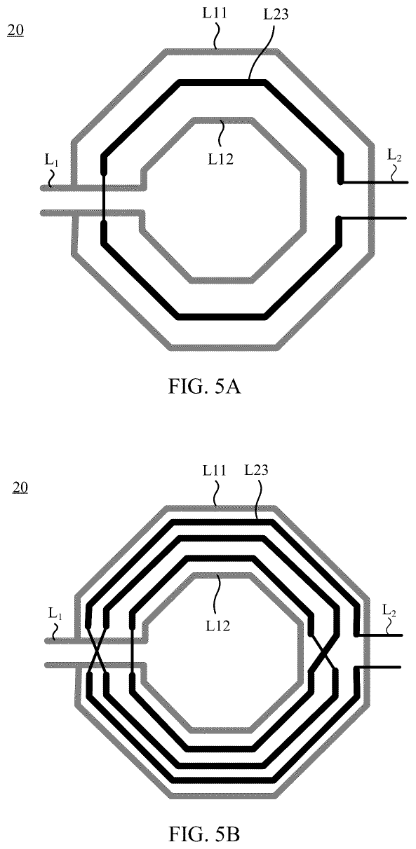

For example, as shown in FIG. 5A, the induction coils 1 L1 of a first inductor L₁ include a first induction coil L11 and a second induction coil L12, and the induction coils 2 L2 of a second inductor L₂ include a third induction coil L23. The third induction coil L23 is disposed between the first induction coil L11 and the second induction coil L12.

As shown in FIG. 5A, only one third induction coil L23 may be disposed between the first induction coil L11 and the second induction coil L12. As shown in FIG. 5B, a plurality of third induction coils L23 may be disposed between a first induction coil L11 and a second induction coil L12.

Certainly, the first inductor L₁ may include a plurality of first induction coils L11 disposed adjacent to each other, and the first inductor L₁ may also include a plurality of second induction coils L12 disposed adjacent to each other. In FIG. 5A and FIG. 5B, an example in which there is one first induction coil L11 and one second induction coil L12 is merely used for illustration.

Alternatively, optionally, a plurality of induction coils 1 L1 are disposed between adjacent induction coils 2 L2.

For example, as shown in FIG. 5C, an induction coil 1 L1 of a first inductor L₁ includes a plurality of first induction coils L11, and an induction coil 2 L2 of a second inductor L₂ includes a third induction coil L23 and a fourth induction coil L24. The plurality of first induction coils L11 are disposed between the third induction coil L23 and the fourth induction coil L24.

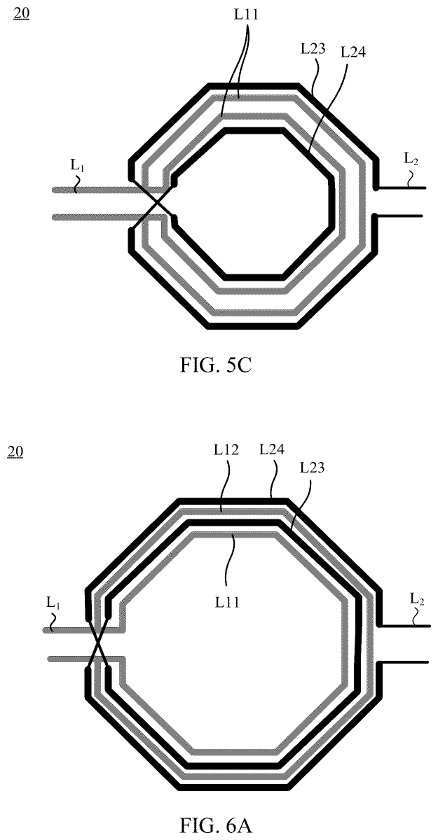

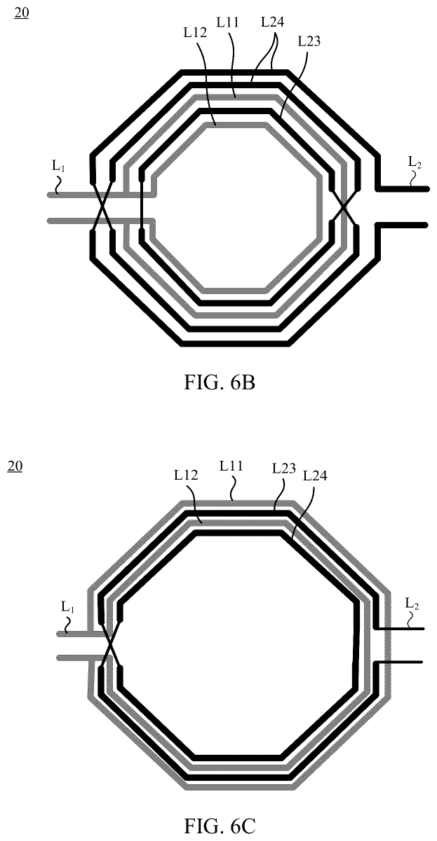

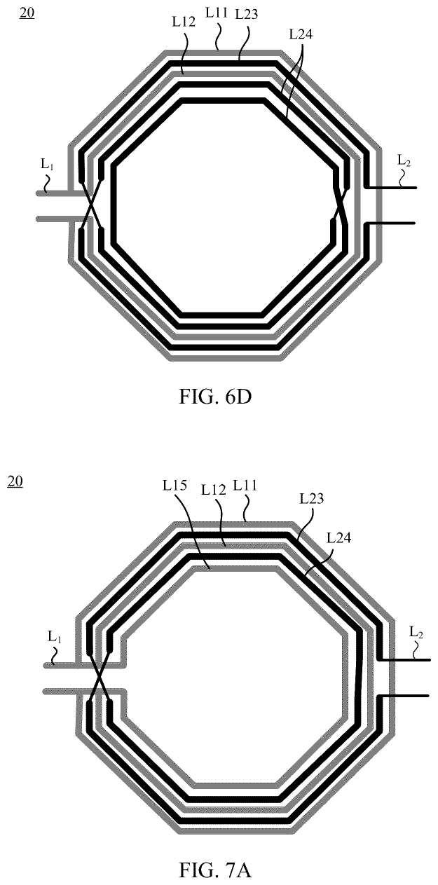

Alternatively, optionally, as shown in FIG. 6A and FIG. 6B, an induction coil 1 L1 of a first inductor L₁ includes a first induction coil L11 and a second induction coil L12, and an induction coil 2 L2 of a second inductor L₂ includes a third induction coil L23 and a fourth induction coil L24. The third induction coil L23 is disposed between the first induction coil L11 and the second induction coil L12, and the second induction coil L12 is disposed between the third induction coil L23 and the fourth induction coil L24.

As shown in FIG. 6A and FIG. 6B, the first induction coil L11 may be located in an innermost ring. As shown in FIG. 6C and FIG. 6D, the first induction coil L11 may alternatively be located in an outermost ring.

Certainly, the first inductor L₁ may include a plurality of first induction coils L11 disposed adjacent to each other, and the first inductor L₁ may also include a plurality of second induction coils L12 disposed adjacent to each other. The second inductor L₂ may include a plurality of third induction coils L23 disposed adjacent to each other, and the second inductor L₂ may also include a plurality of fourth induction coils L24 disposed adjacent to each other. FIG. 6A to FIG. 6D are merely examples. This is not limited.

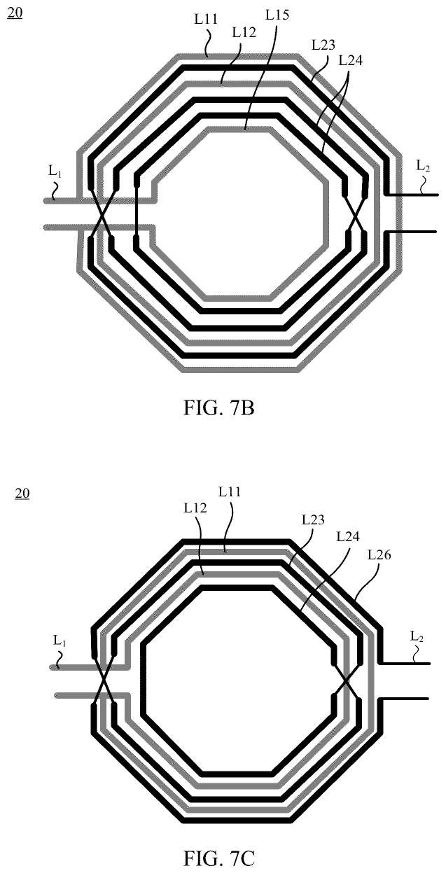

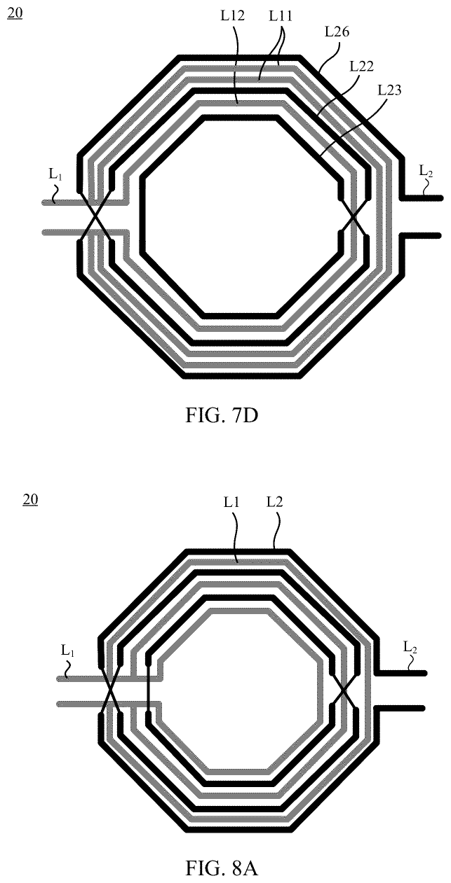

Alternatively, optionally, as shown in FIG. 7A and FIG. 7B, an induction coil 1 L1 of a first inductor L₁ includes a first induction coil L11, a second induction coil L12, and a fifth induction coil L15. An induction coil 2 L2 of a second inductor L₂ includes a third induction coil L23 and a fourth induction coil L24.

The third induction coil L23 is disposed between the first induction coil L11 and the second induction coil L12, the second induction coil L12 is disposed between the third induction coil L23 and the fourth induction coil L24, and the fourth induction coil L24 is disposed between the second induction coil L12 and the fifth induction coil L15.

Certainly, the first inductor L₁ may include a plurality of first induction coils L11 disposed adjacent to each other, the first inductor L₁ may also include a plurality of second induction coils L12 disposed adjacent to each other, and the first inductor L₁ may also include a plurality of fifth induction coils L15 disposed adjacent to each other. The second inductor L₂ may include a plurality of third induction coils L23 disposed adjacent to each other, and the second inductor L₂ may also include a plurality of fourth induction coils L24 disposed adjacent to each other. FIG. 7A and FIG. 7B are merely examples. This is not limited.

Alternatively, optionally, as shown in FIG. 7C and FIG. 7D, an induction coil 1 L1 of a first inductor L₁ includes a first induction coil L11 and a second induction coil L12. An induction coil 2 L2 of a second inductor L₂ includes a third induction coil L23, a fourth induction coil L24, and a sixth induction coil L26.

The third induction coil L23 is disposed between the first induction coil L11 and the second induction coil L12, the second induction coil L12 is disposed between the third induction coil L23 and the fourth induction coil L24, and the first induction coil L11 is disposed between the third induction coil L23 and the sixth induction coil L26.

Certainly, the first inductor L₁ may include a plurality of first induction coils L11 disposed adjacent to each other, and the first inductor L₁ may also include a plurality of second induction coils L12 disposed adjacent to each other. The second inductor L₂ may include a plurality of third induction coils L23 disposed adjacent to each other, the second inductor L₂ may also include a plurality of fourth induction coils L24 disposed adjacent to each other, and the second inductor L₂ may also include a plurality of sixth induction coils L26 disposed adjacent to each other. FIG. 7C and FIG. 7D are merely examples. This is not limited.

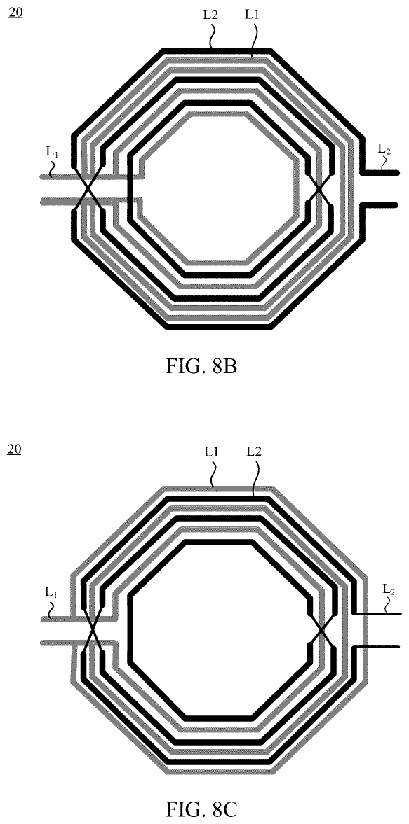

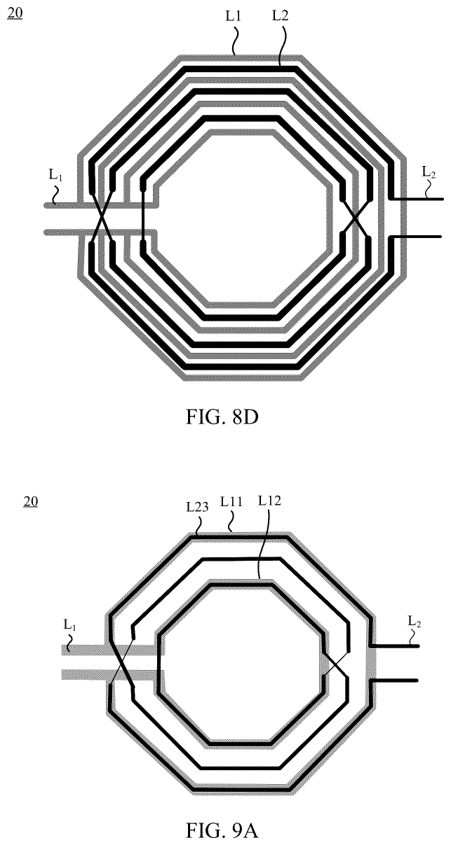

Certainly, as shown in FIG. 8A to FIG. 8D, induction coils 1 L1 in a first inductor L₁ and induction coils 2 L2 in a second inductor L₂ may further be arranged in a nested manner based on any one of the foregoing layout structures. This is not limited in embodiments of this disclosure. In some embodiments, as shown in FIG. 8A and FIG. 8B, an innermost ring of a transformer 20 is an induction coil 1 L1, and an outermost ring of the transformer 20 is an induction coil 2 L2.

In some other embodiments, as shown in FIG. 8C, an innermost ring of a transformer 20 is an induction coil 2 L2, and an outermost ring of the transformer 20 is an induction coil 1 L1.

In still another some embodiments, as shown in FIG. 8D, both an innermost ring and an outermost ring of a transformer 20 are induction coils 1 L1.

To be specific, the induction coils 1 L1 and the induction coils 2 L2 are alternately arranged, and along an arrangement direction of the induction coils 1 L1 and the induction coils 2 L2, both the outermost ring and the innermost ring of the transformer 20 are the induction coils 1 L1 in the first inductor L₁.

In this way, the plurality of induction coils 1 L1 and the plurality of induction coils 2 L2 are nested with each other, the induction coil 1 L1 located in an outermost ring is electromagnetically coupled to one induction coil 2 L2, the induction coil 1 L1 located in an innermost ring is electromagnetically coupled to one induction coil 2 L2, and other induction coils 1 L1 may be electromagnetically coupled to two induction coils 2 L2, so that an overlapping and nesting area of the first inductor L₁ and the second inductor L₂ is largest, and electromagnetic coupling between the induction coils 1 L1 and the induction coils 2 L2 may be increased. When a quantity of the induction coils 1 L1 and a quantity of the induction coils 2 L2 are fixed (that is, an inductance ratio L and an impedance ratio R are fixed), an arrangement manner in which one induction coil 1 L1 is disposed on each of the two sides of each induction coil 2 L2 can maximize a coupling coefficient K of the transformer 20.

In some embodiments, the induction coils 1 L1 and the induction coils 2 L2 are disposed adjacent to each other, and any two induction coils 1 L1 are not adjacent to each other.

To be specific, each of the plurality of parallel-connected induction coils 1 L1 and at least one of the plurality of serial-connected induction coils 2 L2 are adjacently disposed in a stacked manner.

In this way, each induction coil 1 L1 may be electromagnetically coupled to induction coils 2 L2 located on the inner and outer sides of the induction coil 1 L1, so that electromagnetic coupling between the induction coil 1 L1 and the induction coils 2 L2 can be enhanced, to increase a coupling coefficient K of a transformer 20.

Optionally, the plurality of induction coils 1 L1 are four induction coils 1 L1, the plurality of induction coils 2 L2 are three induction coils 2 L2, and the induction coils 1 L1 and the induction coils 2 L2 are alternately arranged and disposed in a nested manner.

In this way, when a transformer 20 is prepared, a process is easy to implement, and the transformer 20 is easy to prepare.

Regardless of how the induction coil 1 L1 and the induction coil 2 L2 are arranged, when the induction coil 1 L1 and the induction coil 2 L2 are disposed at a same layer, a gap may be provided between adjacent induction coils to reduce interference between the adjacent induction coils. To be specific, gaps may be provided between adjacent induction coils 1 L1, between adjacent second induction coils 2 L2, and between an induction coil 1 L1 and an induction coil 2 L2 that are adjacent to each other, to reduce interference between the adjacent induction coils 1 L1, between the adjacent second induction coils 2 L2, and between the induction coil 1 L1 and the induction coil 2 L2 that are adjacent to each other.

A smaller gap between the induction coil 1 L1 and the induction coil 2 L2 indicates better effect of electromagnetic coupling between the induction coil 1 L1 and the induction coil 2 L2. Therefore, during design, electromagnetic coupling effect and process difficulty may be comprehensively considered to determine a size of the gap between the induction coil 1 L1 and the induction coil 2 L2.

In some other embodiments, a part of the plurality of parallel-connected induction coils 1 L1 in the first inductor L1 are disposed at a same layer, and a part of the plurality of serial-connected induction coils 2 L2 in the second inductor L2 are disposed at a same layer.

The plurality of parallel-connected induction coils 1 L1 in the first inductor L1 are distributed at a plurality of layers, and the induction coil 1 L1 and the induction coil 2 L2 that are electromagnetically coupled are arranged in at least one layer, and the induction coil 1 L1 and the induction coil 2 L2 that are located at a same layer are disposed in a nested manner.

For an arrangement manner of the induction coils 1 L1 located at a same layer and the induction coils 2 L2 located at a same layer, refer to the foregoing arrangement manner of the induction coils 1 L1 and the induction coils 2 L2. Details are not described herein again.

Projections of induction coils 1 L1 located at different layers may at least partially overlap, or may not overlap. Projections of induction coils 2 L2 located at different layers may at least partially overlap, or may not overlap. Projections of an induction coil 1 L1 and an induction coil 2 L2 that are located at different layers may at least partially overlap, or may not overlap.

The induction coil 1 L1 and the induction coil 2 L2 that are located at different layers may be coupled or may not be coupled. When the induction coil 1 L1 and the induction coil 2 L2 that are located at different layers are not coupled, an induction coil 1 L1 and an induction coil 2 L2 that are coupled in a transformer 20 are located at a same layer and disposed in a nested manner. When the induction coil 1 L1 and the induction coil 2 L2 that are located at different layers are coupled, an induction coil 1 L1 and an induction coil 2 L2 that are coupled in a transformer 20 are partially located at a same layer and disposed in a nested manner. The induction coil 1 L1 and the induction coil 2 L2 that are coupled in the transformer 20 are partially located at different layers and disposed in a stacked manner.

For an arrangement manner of the induction coil 1 L1 and the induction coil 2 L2 in a case in which the induction coil 1 L1 and the induction coil 2 L2 that are located at different layers are electromagnetically coupled, refer to the following related descriptions of stacked coupling between the induction coil 1 L1 and the induction coil 2 L2.

In terms of a manner in which the first inductor L₁ and the second inductor L₂ are coupled, in another possible implementation, at least one of the plurality of parallel-connected induction coils 1 L1 and at least one of the plurality of serial-connected induction coils 2 L2 are adjacently disposed in a stacked manner.

The first inductor L₁ and the second inductor L₂ are disposed in a stacked manner, and an induction coil 1 L1 in the first inductor L₁ and an induction coil 2 L2 that is in the second inductor L₂ and that is disposed in a stacked manner with the induction coil 1 L1 are electromagnetically coupled.

It should be noted herein that, when the plurality of induction coils 1 L1 and the plurality of induction coils 2 L2 are disposed at different layers, seen from a top view, projections of an induction coil 1 L1 and an induction coil 2 L2 that are coupled may overlap, or may have a gap. Alternatively, it is understood as that a projection of the induction coil 1 L1 on a substrate and a projection of the induction coil 2 L2 on the substrate may overlap, or may have a gap.

In some embodiments, a projection of the induction coil 1 L1 in the first inductor L₁ and a projection of the induction coil 2 L2 in the second inductor L₂ does not overlap.

An arrangement sequence of the projection of the induction coil 1 L1 in the first inductor L₁ and the projections of the induction coil 2 L2 in the second inductor L₂ may be the same as the arrangement sequences shown in FIG. 5A to FIG. 8D. For details, refer to the foregoing related descriptions. Details are not described herein again.

It should be emphasized that, in this example, only an example in which the induction coil 1 L1 and the induction coil 2 L2 are borne by the substrate is used for description. When the induction coil 1 L1 and the second induction coil L2 are borne by another bearing layer, a projection on the substrate described in this example may be understood as a projection on the bearing layer.

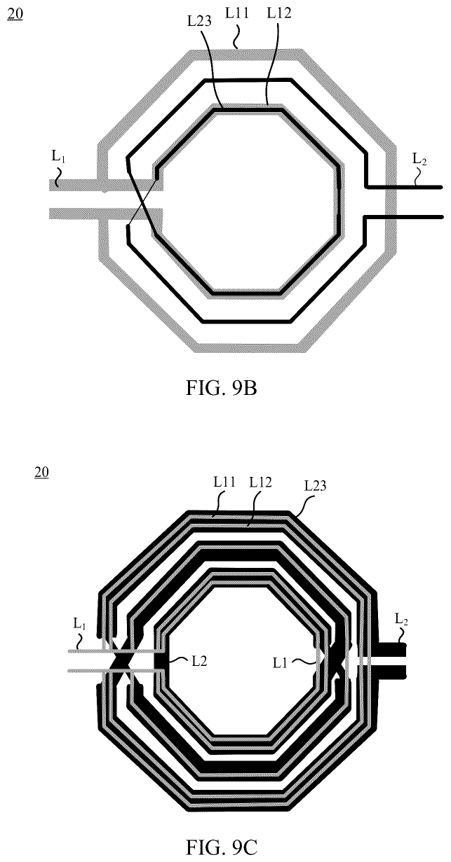

In some other embodiments, as shown in FIG. 9A, projections of at least a part of the plurality of induction coils 1 L1 in the first inductor L₁ and projections of at least a part of the plurality of induction coils 2 L2 in the second inductor L₂ overlap.

To be specific, at least a part of the induction coil 1 L1 is located above at least a part of the induction coil 2 L2, or at least a part of the induction coil 2 L2 is located above at least a part of the induction coil 1 L1. Seen from a top view, at least a part of the induction coil 1 L1 overlaps at least a part of the induction coil 2 L2.

For example, as shown in FIG. 9A, the induction coil 1 L1 of the first inductor L₁ includes a first induction coil L11 and a second induction coil L12, and the induction coil 2 L2 of the second inductor L₂ includes a third induction coil L23. A projection of the first induction coil L11 overlaps a projection of the third induction coil L23.

Alternatively, for example, as shown in FIG. 9B, the induction coil 1 L1 of the first inductor L₁ includes a first induction coil L11 and a second induction coil L12, and the induction coil 2 L2 of the second inductor L₂ includes a third induction coil L23. A projection of the second induction coil L12 overlaps a projection of the third induction coil L23.

Alternatively, for example, as shown in FIG. 9C, the induction coil 1 L1 of the first inductor L₁ includes a first induction coil L11 and a second induction coil L12, and the induction coil 2 L2 of the second inductor L₂ includes a third induction coil L23. Both a projection of the first induction coil L11 and a projection of the second induction coil L12 overlap a projection of the third induction coil L23.

The overlapping may be that the induction coil 1 L1 in the first inductor L₁ at least partially covers the induction coil 2 L2 in the second inductor L₂, or the overlapping may be that the induction coil 2 L2 in the second inductor L₂ at least partially covers the induction coil 1 L1 in the first inductor L1, or the overlapping may be that the induction coil 1 L1 in the first inductor L₁ coincides with the induction coil 2 L2 in the second inductor L₂.

The induction coil 1 L1 and the induction coil 2 L2 are disposed at different layers, and the projection of the induction coil 1 L1 overlaps the projection of the induction coil 2 L2, so that a projection area of a transformer 20 may be small, and in addition, a distance between the induction coil 1 L1 and the induction coil 2 L2 may be minimized, to improve effect of electromagnetic coupling between the induction coil 1 L1 and the induction coil 2 L2.

In some embodiments, each of the plurality of parallel-connected induction coils 1 L1 is coupled to at least one induction coil 2 L2.

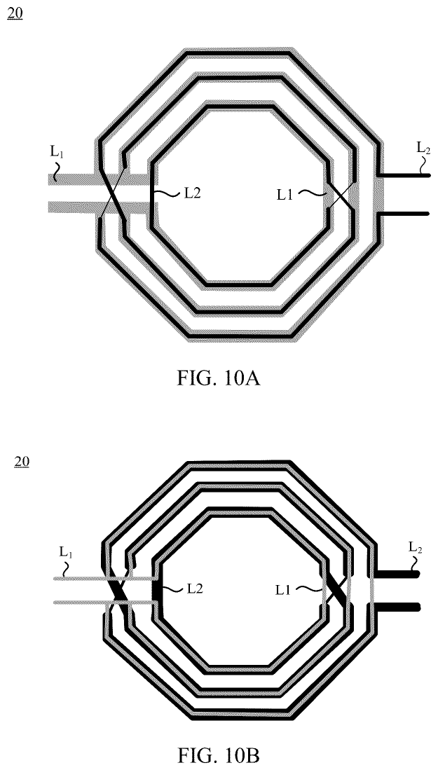

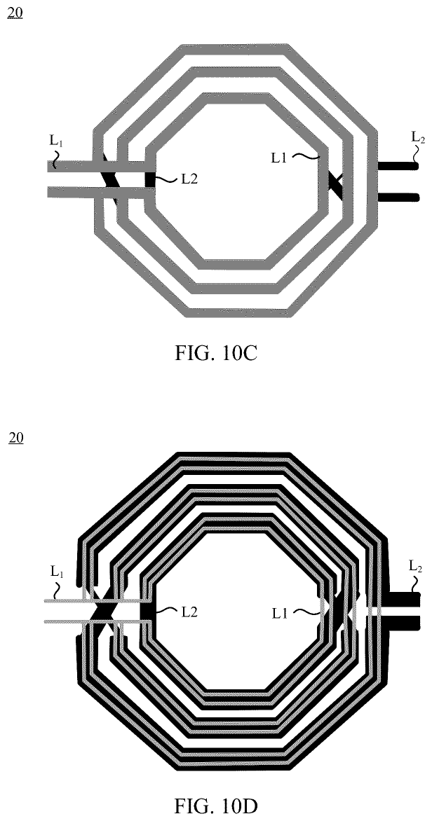

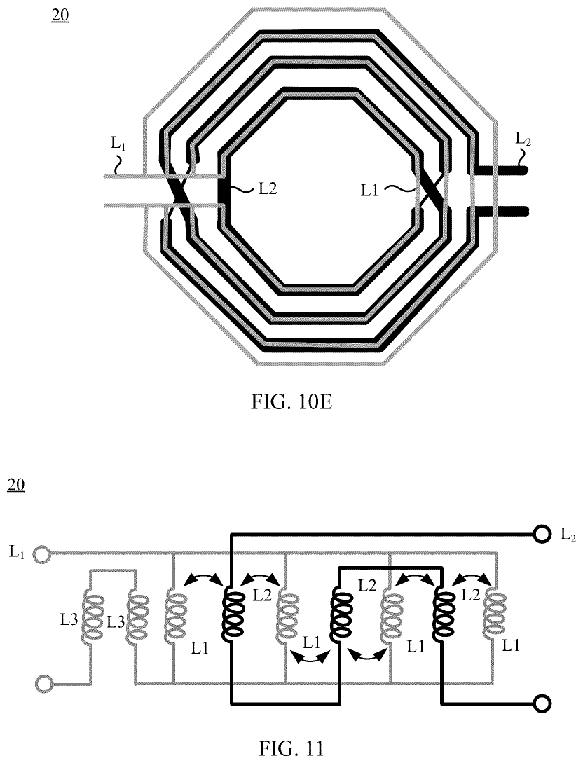

Optionally, as shown in FIG. 10A, a projection of the induction coil 1 L1 on the substrate covers a projection of the induction coil 2 L2 on the substrate.

Alternatively, optionally, as shown in FIG. 10B, a projection of the second induction coil L2 on the substrate covers a projection of the induction coil 1 L1 on the substrate.

Alternatively, optionally, as shown in FIG. 10C, a projection of the induction coil 1 L1 on the substrate coincides with a projection of the induction coil 2 L2 on the substrate.

FIG. 10C uses an example in which the induction coil 1 L1 is located above the induction coil 2 L2. When the projection of the induction coil 1 L1 on the substrate coincides with the projection of the induction coil 2 L2 on the substrate, the induction coil 2 L2 is not displayed in a top view.

It should be noted that, the foregoing overlapping ignores connection parts used to implement serial connection of the plurality of induction coils 1 L1 and parallel connection of the plurality of induction coils 2 L2, is an equivalent result, and is not complete covering or coinciding in a strict sense. In a strict sense, it may be understood as that the projection of the induction coil 1 L1 on the substrate at least partially overlaps the projection of the induction coil 2 L2 on the substrate.

Effect of overlapping between the induction coil 1 L1 and the induction coil 2 L2 may be adjusted by adjusting a line width of the induction coil 1 L1 and a line width of the induction coil 2 L2.

Based on this, for example, as shown in FIG. 10A to FIG. 10C, a quantity of induction coils 1 L₁ in the first inductor L₁ is equal to a quantity of induction coils 2 L2 in the second inductor L₂, and the induction coils 1 L1 and the induction coils 2 L2 are disposed in a one-to-one correspondence.

In this way, the induction coils 1 L1 and the induction coils 2 L2 can be electromagnetically coupled in a one-to-one correspondence manner, and cost-effectiveness is high.

Alternatively, for example, a quantity of induction coil 1 L1 in the first inductor L₁ is not equal to a quantity of induction coil 2 L2 in the second inductor L₂.

For example, as shown in FIG. 10D, projections of at least two induction coils 1 L1 in the first inductor L₁ (FIG. 10D uses two induction coils 1 L1 as an example for illustration) on the substrate overlap a projection of a same induction coil 2 L2 in the second inductor L₂ on the substrate. In other words, a plurality of induction coils 1 L1 in the first inductor L₁ are disposed corresponding to one induction coil 2 L2 in the second inductor L₂.

In this way, when a quantity of induction coils 2 L2 remains unchanged (an inductance value L2′ of the second inductor L₂ remains unchanged), a quantity of induction coils 1 L1 may be increased. Because a plurality of induction coils 1 L1 are connected in parallel, increasing the quantity of induction coils 1 L1 is equivalent to reducing an inductance value L1′ of the first inductor L1, to increase an inductance ratio L (namely, an impedance ratio R) of the transformer 20. In addition, a quantity of the induction coils 1 L1 is increased, and each induction coil 1 L1 is electromagnetically coupled to the induction coil 2 L2, so that an overlapping and nesting area of the induction coils 1 L1 and the induction coil 2 L2 may be increased, thereby increasing a coupling coefficient K of the transformer 20.

Alternatively, for example, projections of a plurality of induction coils 2 L2 in the second inductor L₂ on the substrate overlap a projection of a same induction coil 1 L1 in the first inductor L₁ on the substrate. In other words, a plurality of induction coils 2 L2 are disposed corresponding to one induction coil 1 L1.

In this way, the quantity of induction coils 2 L2 is increased, to increase an inductance value L2′ of the second inductor L₂, so as to increase an inductance ratio L (namely, an impedance ratio R) of the transformer 20. In addition, each induction coil 1 L1 is electromagnetically coupled to the plurality of induction coils 2 L2, so that an overlapping and nesting area of the induction coil 1 L1 and the induction coils 2 L2 may be increased, thereby increasing a coupling coefficient K of the transformer 20.

In some other embodiments, a part of the plurality of parallel-connected induction coils 1 L1 are coupled to at least one induction coil 2 L2, and a part of the induction coils 1 L1 are not coupled to the induction coil 2 L2.

For example, as shown in FIG. 10E, projections of a part of the plurality of induction coils 1 L1 in the first inductor L₁ on the substrate overlap projections of the induction coils 2 L2 in the second inductor L₂ on the substrate, and projections of a part of the induction coils 1 L1 on the substrate do not overlap the projections of the induction coils 2 L2 on the substrate.

For example, a quantity of induction coils 1 L1 in the first inductor L₁ may be greater than a quantity of induction coils 2 L2 in the second inductor L₂. An extra-disposed induction coil 1 L1 may be disposed in an outermost ring, or may be disposed in an innermost ring, or extra-disposed induction coils 1 L1 may be disposed in both an outermost ring and an innermost ring.

The quantity of induction coils 1 L1 is greater than the quantity of induction coils 2 L2, so that the extra-disposed induction coil 1 L1 can reduce an inductance value L1′ of the first inductor L₁ and increase an inductance ratio L (namely, an impedance ratio R) of a transformer 20. In addition, the extra-disposed induction coil 1 L1 may be electromagnetically coupled to an induction coil 2 L2 adjacent to the extra-disposed induction coil 1 L1, to increase an overlapping and nesting area between the induction coil 1 L1 and the induction coil 2 L2, so as to increase a coupling coefficient K of the transformer 20, thereby meeting different requirements.

It should be noted that the plurality of induction coils 1 L1 in the first inductor L₁ may be disposed at a same layer, or may be disposed at different layers, or may be partially disposed at a same layer. The plurality of induction coils 2 L2 in the second inductor L₂ may be disposed at a same layer, or may be disposed at different layers, or may be partially disposed at a same layer.

In some embodiments, the plurality of induction coils 1 L1 in the first inductor L₁ are disposed at a same layer, and the plurality of induction coils 2 L2 in the second inductor L₂ are disposed at a same layer. In this way, a structure is simple, preparation is convenient, and integration is high.

In some embodiments, as shown in FIG. 11, on a basis that the first inductor L₁ includes the plurality of parallel-connected induction coils 1 L1, the first inductor L₁ further includes an induction coil 3 L3 connected in series to the plurality of parallel-connected induction coils 1 L1.

A quantity of induction coils 3 L3 connected in series to the induction coils 1 L1 and arrangement positions of the induction coils 3 L3 are not limited in embodiments of this disclosure, provided that the induction coils 3 L3 are properly disposed as required.

This is an implementable solution, and is used to meet requirements for different inductance ratios L (namely, impedance ratios R) and coupling coefficients K.

Based on this, in terms of a shape of the induction coil 1 L1 and a shape of the induction coil 2 L2, in some embodiments, the induction coil 1 L1 and the induction coil 2 L2 are circular.

In this way, impedance of the induction coil 1 L1 and impedance of the induction coil 2 L2 are continuous, a quality factor of the induction coil 1 L₁ and a quality factor of the induction coil 2 L2 are high, and a loss of the transformer 20 is small.

In some other embodiments, the induction coil 1 L1 and the induction coil 2 L2 are polygonal. In this way, a preparation process of the induction coil 1 L1 and the induction coil 2 L2 is simple, and preparation is easy.

Optionally, an included angle between edges that enclose the induction coil 1 L1 is greater than 90°. Similarly, an included angle between edges that enclose the induction coil 2 L2 is greater than 90°. For example, the shape of the induction coil 1 L1 and the shape of the induction coil 2 L2 are octagons.

In this way, the preparation process of the induction coil 1 L1 and the induction coil 2 L2 is simple, and the preparation is easy. In addition, the impedance of the induction coil 1 L1 and the impedance of the induction coil 2 L2 may be continuous, the quality factor of the induction coil 1 L1 and the quality factor of the induction coil 2 L2 are high, and the loss of the transformer 20 is reduced.

In terms of a manner of connecting the plurality of induction coils 1 L1 in parallel in the first inductor L1, in some embodiments, as shown in FIG. 10E, endpoints of the induction coils 1 L1 in the first inductor L₁ are located on a same straight line.

This can avoid that a part that is of the induction coil 1 L1 and that cannot function as an induction coil is equivalent to a conducting wire. In this way, an effective area of each induction coil 1 L1 is the largest, and an inductance ratio L (namely, an impedance ratio R) and a coupling coefficient K of the transformer 20 are the largest.

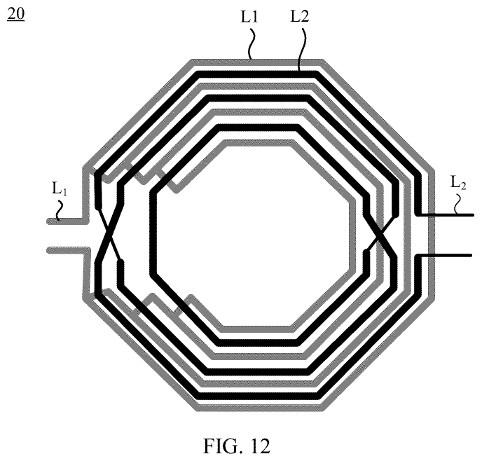

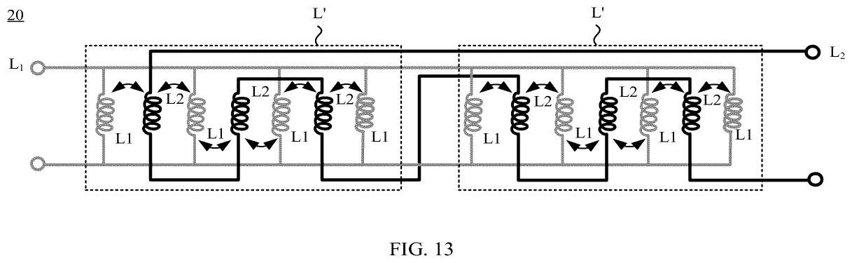

In some other embodiments, as shown in FIG. 12, endpoints of the induction coils 1 L1 in the first inductor L₁ are not located on a same straight line. A coupling position of each induction coil 1 L1 may be adjusted based on an overall layout of a radio frequency chip 200. This is not limited in embodiments of this disclosure.

It should be emphasized that regardless of how the induction coil 1 L1 and the induction coil 2 L2 are arranged, line widths, materials, and shapes of the induction coil 1 L1 and the induction coil 2 L2 are not limited in embodiments of this disclosure. A structure shown in this embodiment of this disclosure is merely an example. This is not limited.

Based on any one of the foregoing structures of a transformer 20, in some embodiments, as shown in FIG. 13, the first inductor L₁ and the second inductor L₂ shown above are used as one inductor group L′, and a transformer 20 includes a plurality of inductor groups L′. First inductors L₁ in the plurality of inductor groups L′ are connected in parallel, and a plurality of second inductors L₂ in the plurality of inductor groups L′ are connected in series.

In FIG. 13, an example in which the transformer 20 includes two inductor groups L′ is used for illustration. However, the transformer 20 is not limited to including only two inductor groups L′ in this embodiment of this disclosure, provided that the inductor groups L′ are properly disposed as required.

Factors such as arrangement manners, quantities, shapes, and widths of the first inductors L₁ and the second inductors L₂ in the plurality of inductor groups L′ included in the transformer 20 may be the same, or may be different, and any combination of any one of the inductor groups L′ shown above may be used.

FIG. 13 is used as an example. A quantity of induction coils 1 L1 that are disposed in parallel and that are included in the first inductors L₁ of the transformer 20 is a sum of quantities of a plurality of induction coils 1 L1 in the two inductor groups L′. A quantity of induction coils 2 L2 that are disposed in series and that are included in the second inductors L₂ of the transformer 20 is a sum of quantities of a plurality of induction coils 2 L2 in the two inductor groups L′.

For example, inductance values of four induction coils 1 L1 in the left inductor group L′ are L1a, L1b, L1c, and Lid, respectively, and inductance values of four induction coils 1 L1 in the right inductor group L′ are L1a′, L1b′, L1c′ and L1d′, respectively. Inductance values of three induction coils 2 L2 in the left inductor group L′ are L2a, L2b, and L2c, respectively, and inductance values of three induction coils 2 L2 in the right inductor group L′ are L2a′, L2b′, L2c′, respectively. In this case, an inductance value L1′ of the first inductors L₁ of the transformer 20 is as follows:

$$L {1}^{′} \approx \frac{1}{( \frac{1}{L 1 a} + \frac{1}{L 1 b} + \frac{1}{L 1 c} + \frac{1}{L 1 d} ) + ( \frac{1}{L 1 {a}^{′}} + \frac{1}{L 1 {b}^{′}} + \frac{1}{L 1 {c}^{′}} + \frac{1}{L 1 {d}^{′}} )} ,$$

and an inductance value L2′ of the second inductors L₂ is as follows: L2′˜(L2a+L2b+L2c)+(L2a′+L2b′+L2c′).

It can be learned from the foregoing descriptions that, compared with a case in which the transformer 20 includes only one inductor group L′, in a case in which the transformer 20 includes a plurality of inductor groups L′, inductance values L1′ of the first inductors L₁ of the transformer 20 are smaller, and inductance values L2′ of the second inductors L₂ of the transformer 20 are larger. Therefore, the transformer 20 can obtain a larger inductance ratio L (namely, impedance ratio R). When a coupling coefficient K of each inductor group L′ is high, a high coupling coefficient K of the transformer 20 may still be maintained. It is found through simulation that, when the transformer 20 includes two inductor groups L′, and a structure of each inductor group L′ is shown in FIG. 4A, an inductance ratio L (namely, an impedance ratio R) of the transformer 20 can reach about 35, and a coupling coefficient K can reach about 0.73.

Therefore, in a case in which a process is difficult to implement because a quantity of induction coils 1 L1 and a quantity of induction coils 2 L2 included in one inductor group L′ are large, a plurality of inductor groups L′ may be disposed to further improve the inductance ratio L (namely, the impedance ratio R) of the transformer 20.

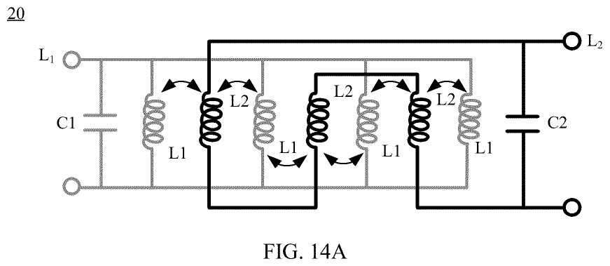

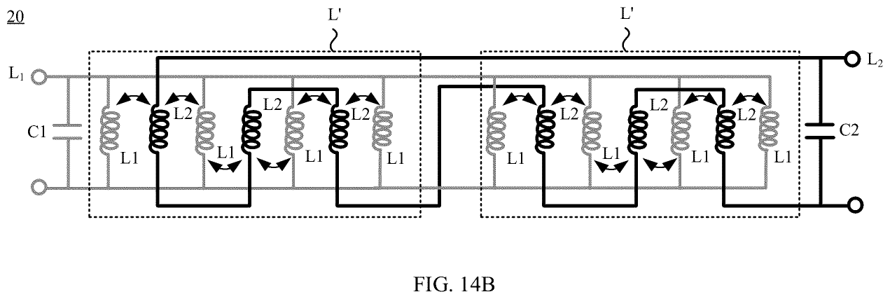

Based on any one of the foregoing structures of a transformer 20, as shown in FIG. 14A and FIG. 14B, a transformer 20 further includes a first capacitor C1 and a second capacitor C2. The first capacitor C1 is connected in parallel to a plurality of induction coils 1 L1, and the second capacitor C2 is connected in parallel to a plurality of induction coils 2 L2.

That the first capacitor C1 is connected in parallel to a plurality of induction coils 1 L1 may be understood as that two ends of the first capacitor C1 are correspondingly coupled to two output ends of the plurality of induction coils 1 L1. That the second capacitor C2 is connected in parallel to a plurality of induction coils 2 L2 may be understood as that two ends of the second capacitor C2 are correspondingly coupled to two output ends of the plurality of induction coils 2 L2.

Disposal positions of the first capacitor C1 and the second capacitor C2 are not limited in embodiments of this disclosure. A plate of the first capacitor C1 and a plate of the second capacitor C2 may be at a same layer as the induction coil 1 L1 and/or the induction coil 2 L2, or a plate of the first capacitor C1 and a plate of the second capacitor C2 may be at different layers from the induction coil 1 L1 and/or the induction coil 2 L2, provided that the first capacitor C1 and the second capacitor C2 are properly disposed as required.

Therefore, in this disclosure, a small inductor is formed through parallel connection, and a large inductor is formed through series connection, so that the transformer 20 has a large inductance ratio L (namely, impedance ratio R). The induction coils 1 L1 and the induction coils 2 L2 are alternately arranged, so that the transformer 20 has a high coupling coefficient K. In this way, the transformer 20 can implement both a large inductance ratio L (namely, impedance ratio R) and a high coupling coefficient K, thereby well implementing low-insertion-loss impedance conversion performance in a scenario with a large impedance ratio matching requirement.

It should be emphasized that the transformer 20 provided in this embodiment of this disclosure is not only applicable to the foregoing radio frequency chip 200, but also may be used in another structure.

An embodiment of this disclosure further provides a circuit board (for example, a PCB). The circuit board includes any one of the foregoing transformers 20. In other words, a transformer 20 may be integrated into the circuit board. Certainly, a first inductor L₁ and a second inductor L₂ may be located at a same wiring layer in the circuit board, or may be located at different wiring layers, provided that the first inductor L₁ and the second inductor L₂ are properly disposed as required.

An embodiment of this disclosure further provides an electronic device, including the foregoing circuit board. The electronic device further includes a low impedance matching network 10 and a high impedance matching network 30. The low impedance matching network 10 and the high impedance matching network 30 are disposed on the circuit board, end parts of a plurality of induction coils 1 L1 in the transformer 20 are coupled to the low impedance matching network 10, and end parts of a plurality of induction coils 2 L2 in the transformer 20 are coupled to the high impedance matching network 30, so as to implement conversion between the low impedance network 10 and the high impedance network 30.

The circuit board and the electronic device provided in embodiments of this disclosure include any one of the foregoing transformers 20. Beneficial effects of the circuit board and the electronic device are the same as the beneficial effects of the transformer 20. Details are not described herein again.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A transformer, comprising:
a first inductor comprising a first plurality of parallel-connected induction coils; and
a second inductor coupled to the first inductor and comprising a second plurality of serial-connected induction coils,
wherein at least a first one of the first plurality and at least a second one of the second plurality are adjacently disposed in a coupling manner.

2. The transformer of claim 1, wherein the at least the first one of the first plurality and the at least the second one of the second plurality are adjacently disposed in a nested manner at a same layer.

3. The transformer of claim 2, further comprising:
an outermost ring; and
an innermost ring,
wherein the first plurality and the second plurality are disposed at the same layer, and
wherein both the outermost ring and the innermost ring comprise a portion of the first plurality.

4. The transformer of claim 1, wherein the first plurality comprises a first induction coil and a second induction coil, wherein the second plurality comprises a third induction coil, and wherein the third induction coil is disposed between the first induction coil and the second induction coil.

5. The transformer of claim 4, wherein the second plurality further comprises a fourth induction coil, and wherein the second induction coil is disposed between the third induction coil and the fourth induction coil.

6. The transformer of claim 5, wherein the first plurality further comprises a fifth induction coil, and wherein the fourth induction coil is disposed between the second induction coil and the fifth induction coil.

7. The transformer of claim 1, wherein the at least the first one and the at least the second one are adjacently disposed in a stacked manner.

8. The transformer of claim 7, wherein a first projection of the at least the first one overlaps a second projection of the at least the second one.

9. The transformer of claim 1, wherein at least a first part of the first plurality is disposed at a same first layer, or wherein at least a second part of the second plurality is disposed at a same second layer.

10. The transformer of claim 1, wherein the first inductor further comprises an induction coil connected in series to the first plurality.

11. The transformer of claim 1, further comprising:
a first capacitor connected in parallel to the first inductor; and
a second capacitor connected in parallel to the second inductor.

12. The transformer of claim 1, further comprising a third plurality of inductor groups, wherein the first inductor and the second inductor serve as one of the third plurality, and wherein each of the third plurality comprises:
a third inductor comprising a fourth plurality of parallel-connected induction coils; and
a fourth inductor comprising a fifth plurality of serial-connected induction coils.

13. A chip, comprising:
a substrate; and
a transformer disposed on the substrate and comprising:
a first inductor comprising a first plurality of parallel-connected induction coils; and
a second inductor coupled to the first inductor and comprising a second plurality of serial-connected induction coils,
wherein at least a first one of the first plurality and at least a second one of the second plurality are adjacently disposed in a coupling manner.

14. The chip of claim 13, further comprising:
a low impedance matching network coupled to the first inductor; and
a high impedance matching network coupled to the second inductor.

15. The chip of claim 13, wherein the at least the first one of the first plurality and the at least the second one of the second plurality are adjacently disposed in a nested manner at a same layer.

16. The chip of claim 15, wherein the transformer further comprises:
an outermost ring; and
an innermost ring,
wherein the first plurality and the second plurality are disposed at the same layer, and
wherein both the outermost ring and the innermost ring comprise a portion of the first plurality.

17. The chip of claim 13, wherein the first plurality comprises a first induction coil and a second induction coil, wherein the second plurality comprises a third induction coil, and wherein the third induction coil is disposed between the first induction coil and the second induction coil.

18. A method, comprising:
electromagnetically coupling a first inductor of a transformer to a second inductor of the transformer, wherein the first inductor comprises a first plurality of parallel-connected induction coils, wherein the second inductor comprises a second plurality of serial-connected induction coils, and wherein at least a first one of the first plurality and at least a second one of the second plurality are adjacently disposed in a coupling manner; and
either:
receiving, by the first inductor, a first signal, and outputting, from the second inductor, the first signal; or
receiving, by the second inductor, a second signal; and outputting, by the first inductor, the second signal.

19. The method of claim 18, further comprising adjacently disposing, in a nested manner at a same layer, the first inductor and the second inductor, wherein electromagnetically coupling the first inductor and the second inductor comprises electromagnetically coupling a first induction coil in the first inductor and a second induction coil that is in the second inductor and that is adjacent to the first induction coil.

20. The method of claim 18, wherein electromagnetically coupling the first inductor and the second inductor comprises adjacently disposing, in a stacked manner, a first induction coil in the first inductor and a second induction coil in the second inductor.
